(19) United States
(12) Patent Application Publication
(10) Pub. No.: US 2006/0271416 A1
(43) Pub. Date: Nov. 30, 2006

(54) Auditing convention housing

(76) Inventors: Richard L. Morgan, Menlo Park, CA (US); Luis Gonzalez, San Francisco, CA (US); Chris Mole, San Jose, CA (US)

Correspondence Address: Donald E. Schreiber;A Professional Corporation, Post Office Box 2926, Kings Beach, CA, 96143-2926, US

(21) Appl. No.: 11/405,996

(22) Filed: Apr. 18, 2006

Related U.S. Application Data
(60) Provisional application No. 60/672,496, filed on Apr. 18, 2005.

(51) Int. Cl. G06Q 10/00

(52) U.S. Cl. 705/5

(57) ABSTRACT

A method by which a sponsor (24) audits convention registrants attending an event who occupy rooms at hotels (26a-26D) that the registrant does not book through the sponsor's housing provider (32). Before the event, the sponsor (24) arranges a commitment from hotels (26A-26D) for a block of rooms during the event. The auditing method includes producing an out-of-block list (64) that identifies registrants who do not appear in an in-block list (56). The out-of-block list (64) is stored on a housing-audit computer (52) from which the hotels (26A-26D) download copies. The hotels (26A-26D) in producing a match list (82) find matches between their guest list (76) and the downloaded copy of the out-of-block list (64). After validating and accepting matches between the lists (64, 76), the hotels (26A-26D) upload the match list (84) to the housing-audit computer (52) for use in producing audit reports (88) supplied to the sponsor (24).

### CLAIM OF PROVISIONAL APPLICATION RIGHTS

This patent application claims the benefit of U.S. Provisional Patent Application No. 60/672,496 on Apr. 18, 2005.

### COPYRIGHT NOTICE

A portion of the disclosure of this patent document contains material that is protected by copyright. The copyright owner hereby grants others a right to reproduce copies of the patent document or the patent disclosure exactly as it appears in the files of the United States Patent and Trademark Office, but otherwise reserves all rights whatsoever under copyright specifically including the right to produce derivative works.

### Compact Disk Appendix

Appendix I hereto, comprising a pair of identical compact disks (“CD-Rs”), is hereby incorporated by reference. The accompanying pair of identical compact disks have the following characteristics.
Machine Format: IBM-PC

Operating System Compatibility: MS-Windows NT 4.0

| | | |
|---|---|---|
| File Name | Size | Creation Date |

List of files for directory

\RoomChecks\Database Scripts

| | | | |
|---|---|---|---|
| 1_tables.sql | 19,614 | 03/29/06 | 07:13a |
| 2_storedprocs.sql | 85,378 | 03/29/06 | 07:14a |
| LkupAuditHotelStatusData.txt | 138 | 03/29/06 | 07:26a |
| LkupAuditStatusData.txt | 139 | 03/29/06 | 07:24a |

List of files for directory

\RoomChecks\Shared Components\AuditCore

| | | | |
|---|---|---|---|
| AssemblyInfo.vb | 1,165 | 06/03/05 | 02:47p |
| AuditCore.vbproj | 3,955 | 12/27/04 | 10:35a |
| AuditCore.vbproj.user | 1,813 | 02/19/06 | 03:11p |
| Constants.vb | 671 | 01/12/05 | 05:10p |
| Core.vb | 38 | 12/10/04 | 01:30p |
| User.vb | 0 | 12/09/04 | 04:46p |

List of files for directory

\RoomChecks\Shared Components\AuditDC

| | | | |
|---|---|---|---|
| AssemblyInfo.vb | 1,165 | 06/03/05 | 02:47p |
| AuditClasses.vb | 2,364 | 01/11/05 | 04:48p |
| AuditDB.vb | 58,090 | 06/07/05 | 01:34p |
| AuditDC.vbproj | 4,608 | 12/27/04 | 08:31p |
| AuditDC.vbproj.user | 1,813 | 02/19/06 | 03:11p |
| DBTools.vb | 3,287 | 12/09/04 | 04:07p |
| FormTools.vb | 3,333 | 12/27/04 | 08:51a |

List of files for directory

\RoomChecks\Shared Components\PasswordGen

| | | | |
|---|---|---|---|
| AssemblyInfo.cs | 2,532 | 06/03/05 | 02:47p |
| Copy of PasswordGenerator.cs | 6,551 | 01/15/05 | 07:13p |
| PasswordGen.csproj | 3,916 | 01/15/05 | 07:13p |
| PasswordGen.csproj.user | 1,803 | 02/19/06 | 03:11p |
| PasswordGenerator.cs | 4,720 | 01/15/05 | 07:15p |

List of files for directory

\RoomChecks\SiteCore

| | | | |
|---|---|---|---|
| AssemblyInfo.vb | 1,165 | 06/03/05 | 02:47p |
| RoomChecksBasePage.vb | 273 | 02/14/05 | 05:09a |
| SiteCore.vbproj | 3,889 | 01/13/05 | 04:06a |
| SiteCore.vbproj.user | 1,815 | 02/19/06 | 03:11p |

List of files for directory

\RoomChecks\Visual Studio Main Solution

| | | | |
|---|---|---|---|
| Roomchecks.sln | 6,592 | 03/01/05 | 09:30p |

List of files for directory

\RoomChecks\Web Service\RoomchecksServices

| | | | |
|---|---|---|---|
| AssemblyInfo.vb | 1,097 | 06/03/05 | 02:51p |
| AuditService.asmx | 116 | 12/27/04 | 10:30a |
| AuditService.asmx.resx | 1,733 | 01/29/02 | 09:05p |
| AuditService.asmx.vb | 25,083 | 01/28/06 | 05:33p |
| AuditService.vbproj | 5,644 | 12/28/04 | 04:04p |
| AuditService.vbproj.webinfo | 114 | 03/29/06 | 07:44a |
| AuditService.vsdisco | 319 | 12/07/04 | 10:45a |
| Global.asax | 92 | 12/27/04 | 10:27a |
| Global.asax.resx | 1,733 | 09/19/01 | 02:24p |
| Global.asax.vb | 2,363 | 04/07/05 | 08:11a |
| Web.config | 13,832 | 01/16/05 | 03:45p |

List of files for directory

\RoomChecks\Web Site Apps\RoomchecksAdmin

| | | | |
|---|---|---|---|
| AdminLogin.aspx | 2,022 | 05/18/05 | 12:21p |
| AdminLogin.aspx.resx | 1,733 | 09/19/01 | 02:24p |
| AdminLogin.aspx.vb | 1,583 | 04/17/05 | 11:03a |
| AdminSite.vbproj | 8,352 | 02/02/06 | 10:51a |
| AdminSite.vbproj.webinfo | 108 | 03/29/06 | 07:44a |
| AdminSite.vsdisco | 319 | 11/17/04 | 02:38a |
| AssemblyInfo.vb | 1,097 | 06/03/05 | 02:51p |
| AuditDetail.aspx | 5,239 | 06/03/05 | 02:41p |
| AuditDetail.aspx.resx | 1,733 | 01/29/02 | 09:05p |
| AuditDetail.aspx.vb | 4,780 | 06/03/05 | 02:33p |
| AuditList.aspx | 8,201 | 06/03/05 | 02:39p |
| AuditList.aspx.resx | 1,733 | 09/19/01 | 02:24p |
| AuditList.aspx.vb | 6,313 | 06/02/05 | 03:41p |
| Global.asax | 89 | 12/27/04 | 09:51a |
| Global.asax.resx | 1,733 | 09/19/01 | 02:24p |
| Global.asax.vb | 1,800 | 11/17/04 | 02:38a |
| testhotel.htm | 74 | 12/29/04 | 10:02a |
| Web.config | 14,181 | 01/14/05 | 02:24p |

List of files for directory

\RoomChecks\Web Site Apps\RoomchecksAdmin\Controls

| | | | |
|---|---|---|---|
| Copy of SiteFooter.ascx | 1,150 | 04/17/05 | 08:50a |
| Copy of SiteFooter.ascx.resx | 1,733 | 09/19/01 | 02:24p |
| Copy of SiteFooter.ascx.vb | 757 | 04/17/05 | 08:50a |
| Copy of SiteHeader.ascx | 4,866 | 04/17/05 | 08:50a |
| Copy of SiteHeader.ascx.resx | 1,733 | 09/19/01 | 02:24p |
| Copy of SiteHeader.ascx.vb | 757 | 04/17/05 | 08:50a |
| SiteFooter.ascx | 1,141 | 04/22/05 | 02:12p |
| SiteFooter.ascx.resx | 1,733 | 09/19/01 | 02:24p |
| SiteFooter.ascx.vb | 756 | 07/07/04 | 06:06a |
| SiteHeader.ascx | 1,019 | 04/17/05 | 08:52a |
| SiteHeader.ascx.resx | 1,733 | 09/19/01 | 02:24p |
| SiteHeader.ascx.vb | 756 | 07/05/04 | 11:30a |

List of files for directory

\RoomChecks\Web Site Apps\RoomchecksHotel

| | | | |
|---|---|---|---|
| AssemblyInfo.vb | 1,097 | 06/03/05 | 02:51p |
| Global.asax | 89 | 12/27/04 | 08:59a |
| Global.asax.resx | 1,733 | 09/19/01 | 02:24p |
| Global.asax.vb | 1,800 | 06/06/04 | 09:08p |
| HotelForgotPassword.aspx | 2,601 | 04/22/05 | 02:18p |
| HotelForgotPassword.aspx.resx | 1,733 | 01/29/02 | 09:05p |
| HotelForgotPassword.aspx.vb | 1,788 | 01/15/05 | 12:16a |
| HotelLogin.aspx | 4,628 | 05/18/05 | 12:19p |
| HotelLogin.aspx.resx | 1,733 | 09/19/01 | 02:24p |
| HotelLogin.aspx.vb | 1,614 | 04/15/05 | 12:00p |
| HotelSite.vbproj | 10,280 | 02/02/06 | 10:51a |
| HotelSite.vbproj.webinfo | 108 | 03/29/06 | 07:44a |
| HotelSite.vsdisco | 319 | 06/06/04 | 09:08p |
| licenses.licx | 54 | 06/07/04 | 03:52a |
| Web.config | 14,381 | 01/14/05 | 02:24p |

List of files for directory

\RoomChecks\Web Site Apps\RoomchecksHotel\Audit

| | | | |
|---|---|---|---|
| Process.aspx | 3,853 | 11/13/05 | 02:40a |
| Process.aspx.resx | 1,733 | 09/19/01 | 02:24p |
| Process.aspx.vb | 1,804 | 04/15/05 | 12:36p |

List of files for directory

\RoomChecks\Web Site Apps\RoomchecksHotel\Controls

| | | | |
|---|---|---|---|
| FrameworkVersion.ascx | 2,272 | 04/27/05 | 02:56p |
| FrameworkVersion.ascx.resx | 1,733 | 01/29/02 | 09:05p |
| FrameworkVersion.ascx.vb | 1,501 | 04/12/05 | 06:29a |
| SiteFooter.ascx | 1,141 | 04/22/05 | 02:11p |
| SiteFooter.ascx.resx | 1,733 | 09/19/01 | 02:24p |
| SiteFooter.ascx.vb | 756 | 07/07/04 | 06:06a |
| SiteHeader.ascx | 1,007 | 04/15/05 | 11:55a |
| SiteHeader.ascx.resx | 1,733 | 09/19/01 | 02:24p |
| SiteHeader.ascx.vb | 756 | 07/05/04 | 11:30a |

List of files for directory

\RoomChecks\Web Site Apps\RoomchecksHotel\Reports

| | | | |
|---|---|---|---|
| RptAuditHotel.rpx | 1,947 | 04/30/02 | 09:02a |
| RptAuditHotel.vb | 824 | 06/14/04 | 12:06a |

List of files for directory

\RoomChecks\Web Site Apps\RoomchecksHotel\hotel-bin

| | | | |
|---|---|---|---|
| HotelWizard.exe.config | 75 | 12/29/04 | 10:11a |

List of files for directory

\RoomChecks\Web Site Apps\RoomchecksMain

| | | | |
|---|---|---|---|
| agreement.aspx | 18,263 | 10/18/05 | 07:49p |
| agreement.aspx.resx | 1,733 | 01/29/02 | 09:05p |
| agreement.aspx.vb | 943 | 01/13/05 | 11:33a |
| AssemblyInfo.vb | 1,097 | 06/03/05 | 02:51p |
| contact.aspx | 2,942 | 05/18/05 | 02:05p |
| contact.aspx.resx | 1,733 | 01/29/02 | 09:05p |
| contact.aspx.vb | 941 | 01/13/05 | 11:34a |
| error.aspx | 1,718 | 04/17/05 | 06:58a |
| error.aspx.resx | 1,733 | 01/29/02 | 09:05p |
| error.aspx.vb | 940 | 01/13/05 | 11:30a |
| faq.aspx | 53,397 | 10/18/05 | 07:49p |
| faq.aspx.resx | 1,733 | 01/29/02 | 09:05p |
| faq.aspx.vb | 937 | 01/13/05 | 11:34a |
| Global.asax | 88 | 12/27/04 | 09:32a |
| Global.asax.resx | 1,733 | 09/19/01 | 02:24p |
| Global.asax.vb | 1,800 | 07/07/04 | 07:15a |
| home.aspx | 3,599 | 04/27/05 | 12:51p |
| home.aspx.resx | 1,733 | 01/29/02 | 09:05p |
| home.aspx.vb | 938 | 01/13/05 | 11:34a |
| HotelRoomingListSample.aspx | 3,389 | 04/17/05 | 06:48a |
| HotelRoomingListSample.aspx.resx | 1,733 | 01/29/02 | 09:05p |
| HotelRoomingListSample.aspx.vb | 956 | 01/13/05 | 11:34a |
| howitworks.aspx | 5,230 | 05/18/05 | 01:58p |
| howitworks.aspx.resx | 1,733 | 01/29/02 | 09:05p |
| howitworks.aspx.vb | 944 | 01/13/05 | 11:35a |
| index.aspx | 2,412 | 04/22/05 | 03:40p |
| index.aspx.resx | 1,733 | 01/29/02 | 09:05p |
| index.aspx.vb | 939 | 01/13/05 | 11:35a |
| MainSite.vbproj | 13,642 | 02/02/06 | 10:48a |
| MainSite.vbproj.webinfo | 101 | 03/29/06 | 07:44a |
| MainSite.vsdisco | 319 | 07/07/04 | 07:15a |
| privacy.aspx | 8,289 | 10/18/05 | 07:43p |
| privacy.aspx.resx | 1,733 | 01/29/02 | 09:05p |
| privacy.aspx.vb | 941 | 01/13/05 | 11:35a |
| RegistrationListSample.aspx | 3,333 | 04/17/05 | 06:52a |
| RegistrationListSample.aspx.resx | 1,733 | 01/29/02 | 09:05p |
| RegistrationListSample.aspx.vb | 932 | 01/16/05 | 12:54p |
| sitemap.aspx | 2,805 | 04/27/05 | 12:09p |
| sitemap.aspx.resx | 1,733 | 01/29/02 | 09:05p |
| sitemap.aspx.vb | 941 | 01/13/05 | 11:35a |
| test.aspx | 6,394 | 04/07/05 | 12:22a |
| test.aspx.resx | 1,733 | 01/29/02 | 09:05p |
| test.aspx.vb | 914 | 03/24/05 | 10:22p |
| Web.config | 14,223 | 04/19/05 | 09:33a |
| whatwedo.aspx | 6,494 | 04/27/05 | 01:06p |
| whatwedo.aspx.resx | 1,733 | 01/29/02 | 09:05p |
| whatwedo.aspx.vb | 942 | 01/13/05 | 11:35a |

List of files for directory

\RoomChecks\Web Site Apps\RoomchecksMain\Controls

| | | | |
|---|---|---|---|
| SiteFooter.ascx | 1,140 | 04/22/05 | 02:07p |
| SiteFooter.ascx.resx | 1,733 | 09/19/01 | 02:24p |
| SiteFooter.ascx.vb | 756 | 07/07/04 | 06:06a |
| SiteHeader.ascx | 1,019 | 04/19/05 | 11:53p |
| SiteHeader.ascx.resx | 1,733 | 09/19/01 | 02:24p |
| SiteHeader.ascx.vb | 756 | 07/05/04 | 11:30a |

List of files for directory

\RoomChecks\Web Site Apps\RoomchecksMain\Pages

| | | | |
|---|---|---|---|
| main.html | 5,020 | 04/27/05 | 12:44p |

List of files for directory

\RoomChecks\Web Site Apps\RoomchecksMain\Styles

| | | | |
|---|---|---|---|
| rchecks.css | 5,142 | 05/18/05 | 01:30p |

List of files for directory

\RoomChecks\Web Site Apps\RoomchecksMain\Styles\older

| | | | |
|---|---|---|---|
| Common.css | 84 | 07/07/04 | 09:30a |
| Roomchecks.css | 3,772 | 04/15/05 | 06:20a |
| Roomchecks-old.css | 2,497 | 07/07/04 | 08:07a |

List of files for directory

\RoomChecks\Web Site Apps\RoomchecksMain\Web launch_files

| | | | |
|---|---|---|---|
| filelist.xml | 171 | 01/07/05 | 02:15p |
| WS_FTP.LOG | 250 | 01/07/05 | 02:26p |

List of files for directory

\RoomChecks\Web Site Apps\RoomchecksMain\aspnet_client\

system_web\1_0_3705_288

| | | | |
|---|---|---|---|
| SmartNav.js | 8,709 | 05/10/02 | 09:16p |
| SmartNavIE5.js | 7,003 | 05/10/02 | 09:16p |
| WebUIValidation.js | 14,604 | 11/21/01 | 01:19p |

List of files for directory

\RoomChecks\Web Site Apps\RoomchecksSponsor

| | | | |
|---|---|---|---|
| AssemblyInfo.vb | 1,099 | 06/03/05 | 02:51p |
| DataSet1.vb | 53,175 | 05/31/04 | 12:58p |
| DataSet1.xsd | 3,495 | 05/31/04 | 12:58p |
| Global.asax | 91 | 12/27/04 | 08:27a |
| Global.asax.resx | 1,733 | 09/19/01 | 02:24p |
| Global.asax.vb | 2,363 | 04/07/05 | 08:11a |
| licenses.licx | 54 | 06/26/04 | 03:57a |
| NewLogin.aspx | 4,472 | 04/15/05 | 10:54a |
| NewLogin.aspx.resx | 1,733 | 01/29/02 | 09:05p |
| NewLogin.aspx.vb | 1,745 | 04/12/05 | 06:29a |
| newpresignup.aspx | 3,650 | 04/15/05 | 10:36a |
| newpresignup.aspx.resx | 1,733 | 01/29/02 | 09:05p |
| newpresignup.aspx.vb | 922 | 04/12/05 | 08:22a |
| newsignup.aspx | 8,332 | 04/15/05 | 10:51a |
| newsignup.aspx.resx | 1,733 | 01/29/02 | 09:05p |
| newsignup.aspx.vb | 4,397 | 04/15/05 | 10:46a |
| PreSignup.aspx | 3,685 | 05/18/05 | 12:05p |
| PreSignup.aspx.resx | 1,733 | 09/19/01 | 02:24p |
| PreSignUp.aspx.vb | 950 | 04/15/05 | 10:39a |
| PreSignup-orig.aspx | 3,574 | 04/27/05 | 01:09p |
| Signup.aspx | 8,322 | 05/18/05 | 12:17p |
| SignUp.aspx.resx | 1,733 | 09/19/01 | 02:24p |
| Signup.aspx.vb | 4,392 | 01/15/05 | 07:19p |
| SponorSite.vbproj | 13,150 | 02/02/06 | 10:51a |
| SponorSite.vbproj.webinfo | 111 | 03/29/06 | 07:44a |
| Sponsor.aspx | 5,753 | 06/01/04 | 04:57a |
| Sponsor.aspx.resx | 1,733 | 09/19/01 | 02:24p |
| Sponsor.aspx.vb | 6,505 | 06/01/04 | 04:57a |
| SponsorConfirmation.aspx | 2,002 | 04/27/05 | 01:10p |
| SponsorConfirmation.aspx.resx | 1,733 | 09/19/01 | 02:24p |
| SponsorConfirmation.aspx.vb | 724 | 01/13/05 | 11:38a |
| SponsorConfirmation2.aspx | 1,216 | 07/07/04 | 08:34a |
| SponsorForgotPassword.aspx | 2,607 | 04/22/05 | 02:29p |
| SponsorForgotPassword.aspx.resx | 1,733 | 01/29/02 | 09:05p |
| SponsorForgotPassword.aspx.vb | 1,783 | 01/15/05 | 12:16a |
| SponsorLogin.aspx | 4,277 | 05/18/05 | 02:13p |
| SponsorLogin.aspx.resx | 1,733 | 09/19/01 | 02:24p |
| SponsorLogin.aspx.vb | 1,745 | 04/27/05 | 02:14p |
| SponsorSite.vsdisco | 319 | 05/31/04 | 12:31p |
| Web.config | 14,845 | 04/19/05 | 09:28a |

List of files for directory

\RoomChecks\Web Site Apps\RoomchecksSponsor\Audit

| | | | |
|---|---|---|---|
| AuditHotelInfo.aspx | 2,240 | 12/27/04 | 08:41a |
| AuditHotelInfo.aspx.resx | 1,733 | 09/19/01 | 02:24p |
| AuditHotelInfo.aspx.vb | 3,053 | 12/23/04 | 11:31p |
| Manage.aspx | 13,654 | 06/03/05 | 07:37p |
| Manage.aspx.resx | 1,733 | 09/19/01 | 02:24p |
| Manage.aspx.vb | 14,328 | 04/15/05 | 06:35a |
| newmanage.aspx | 13,843 | 04/15/05 | 09:52a |
| newmanage.aspx.resx | 1,733 | 01/29/02 | 09:05p |
| newmanage.aspx.vb | 14,409 | 04/15/05 | 06:36a |

List of files for directory

\RoomChecks\Web Site Apps\RoomchecksSponsor\Controls

| | | | |
|---|---|---|---|
| FrameworkVersion.ascx | 2,275 | 04/27/05 | 12:20p |
| FrameworkVersion.ascx.resx | 1,733 | 01/29/02 | 09:05p |
| FrameworkVersion.ascx.vb | 1,501 | 04/12/05 | 06:29a |
| NewFooter.ascx | 1,048 | 04/09/05 | 11:31a |
| NewFooter.ascx.resx | 1,733 | 01/29/02 | 09:05p |
| NewFooter.ascx.vb | 926 | 04/07/05 | 12:45a |
| NewHeader.ascx | 1,008 | 04/14/05 | 12:16p |
| NewHeader.ascx.resx | 1,733 | 01/29/02 | 09:05p |
| NewHeader.ascx.vb | 926 | 04/07/05 | 12:44a |
| SiteFooter.ascx | 1,143 | 04/22/05 | 02:09p |
| SiteFooter.ascx.resx | 1,733 | 09/19/01 | 02:24p |
| SiteFooter.ascx.vb | 756 | 07/07/04 | 06:06a |
| SiteHeader.ascx | 1,027 | 04/16/05 | 06:46a |
| SiteHeader.ascx.resx | 1,733 | 09/19/01 | 02:24p |
| SiteHeader.ascx.vb | 756 | 07/05/04 | 11:30a |

List of files for directory

\RoomChecks\Web Site Apps\RoomchecksSponsor\Reports

| | | | |
|---|---|---|---|
| RptAudit.rpx | 12,535 | 02/02/06 | 11:16a |
| RptAudit.vb | 10,233 | 02/02/06 | 11:16a |
| RptAuditSummary.rpx | 5,203 | 01/21/05 | 09:42a |
| RptAuditSummary.vb | 4,940 | 01/21/05 | 09:42a |

List of files for directory

\RoomChecks\Web Site Apps\RoomchecksSponsor\components

| | | | |
|---|---|---|---|
| AppDB.vb | 5,429 | 12/23/04 | 11:30p |
| DBTools.vb | 3,287 | 06/06/04 | 10:50a |

List of files for directory

\RoomChecks\Web Site Apps\RoomchecksSponsor\sponsor-bin

| | | | |
|---|---|---|---|
| Copy of SponsorWizard.exe.config | 174 | 07/28/04 | 05:52a |
| SponsorWizard.exe.config | 75 | 12/29/04 | 10:11a |

List of files for directory

\RoomChecks\Windows-Wizard Apps\HotelWizard

| | | | |
|---|---|---|---|
| AssemblyInfo.vb | 1,248 | 06/03/05 | 02:47p |
| BoolValueChangedEventArgs.vb | 1,114 | 12/28/04 | 06:03p |
| ClickableBooleanColumn.resx | 1,733 | 12/28/04 | 06:03p |
| ClickableBooleanColumn.vb | 3,250 | 01/03/05 | 06:21p |
| Globals.vb | 812 | 12/28/04 | 10:08p |
| HotelWizard.vbproj | 7,646 | 06/06/05 | 02:42p |
| HotelWizard.vbproj.user | 1,814 | 02/19/06 | 03:11p |
| HotelWizardForm.resx | 73,553 | 06/02/05 | 04:28p |
| HotelWizardForm.vb | 128,843 | 06/02/05 | 04:28p |
| LoginForm.resx | 23,753 | 06/03/05 | 12:38p |
| LoginForm.vb | 11,424 | 06/03/05 | 12:38p |
| WebProxyWithoutKeepAlive.vb | 347 | 01/09/05 | 04:58p |

List of files for directory

\RoomChecks\Windows-Wizard Apps\HotelWizard\

Web References\RoomChecksWS

| | | | |
|---|---|---|---|
| auditservice.disco | 568 | 06/06/05 | 02:41p |
| auditservice.wsdl | 19,794 | 06/06/05 | 02:41p |
| Reference.map | 594 | 06/06/05 | 02:41p |
| Reference.vb | 19,171 | 06/06/05 | 02:41p |

List of files for directory

\RoomChecks\Windows-Wizard Apps\SponsorWizard

| | | | |
|---|---|---|---|
| AssemblyInfo.vb | 1,248 | 06/03/05 | 02:47p |
| Fix for Web Service Timeout.txt | 414 | 01/03/05 | 12:34p |
| Form1.resx | 25,827 | 01/16/05 | 01:38a |
| Form1.vb | 25,235 | 01/16/05 | 01:39a |
| Globals.vb | 782 | 12/27/04 | 10:45a |
| LoginForm.resx | 23,753 | 05/02/05 | 10:48p |
| LoginForm.vb | 11,098 | 05/02/05 | 10:48p |
| Roomchecks.sln | 6,592 | 03/01/05 | 09:30p |
| SponsorWizard.vbproj | 7,410 | 06/06/05 | 02:42p |
| SponsorWizard.vbproj.user | 1,814 | 02/19/06 | 03:11p |
| SponsorWizardForm.resx | 74,826 | 06/02/05 | 04:28p |
| SponsorWizardForm.vb | 101,771 | 06/02/05 | 04:28p |
| WebProxyWithoutKeepAlive.vb | 347 | 01/15/05 | 12:40p |

List of files for directory

\RoomChecks\Windows-Wizard Apps\SponsorWizard\

Web References\RoomChecksWS

| | | | |
|---|---|---|---|
| auditservice.disco | 568 | 06/06/05 | 02:42p |
| auditservice.wsdl | 19,794 | 06/06/05 | 02:42p |
| Reference.map | 594 | 06/06/05 | 02:42p |
| Reference.vb | 19,171 | 06/06/05 | 02:42p |

List of files for directory

\RoomChecks\Windows-Wizard Apps\WizardCore

| | | | |
|---|---|---|---|
| AssemblyInfo.vb | 1,165 | 06/03/05 | 02:47p |
| DataGridSelectedColumnStyle.resx | 1,733 | 01/29/02 | 09:05p |
| DataGridSelectedColumnStyle.vb | 850 | 05/02/05 | 11:03p |
| Exceptions.vb | 173 | 12/16/04 | 01:30p |
| ListUtils.vb | 390 | 12/16/04 | 01:30p |
| UserSettings.vb | 500 | 12/11/04 | 02:16p |
| Utils.vb | 53,585 | 01/21/05 | 01:47p |
| WizardCore.vbproj | 5,609 | 02/22/05 | 05:05p |

### BACKGROUND

1. Technical Field

The present disclosure relates generally to management of short-term lodging, and particularly to a system for auditing registrants' housing for an event such as a convention or other analogous gathering.

1. Background Art

There exists a community of economic interests among various enterprises which join together in an ad hoc collaboration to conduct an event such as a convention or other analogous gathering. Initially there is the enterprise which sponsors and organizes the event, and which advertises the event both to its members and to others who might possibly be interested in attending. During an interval of nine (9) to eighteen (18) months before an event's scheduled dates, as indicated by arrows 22a-22d in the block diagram of FIG. 1, a sponsor 24 contracts individually with various hotels 26a-26d. (As used herein the word “hotel” includes without limitation any type of enterprise which provides traveler accommodations such as hotels, motels, motor lodges, motor courts, pensions, boardinghouses, lodges, camps, inns, dude ranches, recreational resorts, etc.) These contracts commit the hotels 26a-26d to reserving for booking via the sponsor 24 a specified number of rooms throughout a block of dates thereby making them available to house the event's attendees. In exchange for the commitment by the hotels 26a-26d to make the specified number of rooms available during the block of dates, the sponsor 24 may become contractually obligated to make an attrition payment to the hotel 26a-26d if occupancy for the event falls below a specified minimum amount of room-nights on a day-by-day or cumulative basis. The minimum amount of room-nights is generally specified to be 80% to 90% of the total room block, or 80% to 90% of the room block on an event's peak night. The actual percentage is subject to agreement between the sponsor 24 and the hotel 26a-26d during contract negotiation.

In connection with organizing lodging for the event's registrants, the sponsor 24 may arrange with a housing provider 32, as indicated by a dashed, curved arrow 34 in FIG. 1, to mediate between registrants and the hotels 26a-26d in booking reservations, indicated by arrows 36a-36d, for attendees lodging. To facilitate booking reservations, the sponsor 24 frequently provides the housing provider 32 with information about registrants indicated by a curved arrow 38. While FIG. 1 depicts the housing provider 32 as being distinct from the sponsor 24, depending upon individual situations, the housing provider 32 may, in fact, be part of the sponsor 24, may be a distinct enterprise which contracts with the sponsor 24, or may be part of a convention visitors bureau (“CVB”) 42 usually operating in the geographical region where the event will occur.

The principal economic benefits which accrue to the sponsor 24 for contracting with the hotels 26a-26d for the “blocks” and with the housing provider 32 to handle reservations within the blocks are that the hotels 26a-26d may:

1. pay compensation to the sponsor 24 for each registrant that the hotel 26a-26d books; and/or

2. in exchange for holding and filling larger blocks of rooms, provide the sponsor 24 with other ancillary benefits such as a reduced rate for or even free meeting room space, VIP upgrades, and/or complementary lodging.

A less significant economic benefit which accrues to the sponsor 24 for contracting with the hotels 26a-26d for the block is that it becomes easier for registrants to arrange lodging because rooms in the blocks respectively committed by the hotels 26a-26d cannot be reserved by others during the event's dates. It is readily apparent that a possible registrant is less likely to attend an event if they encounter difficulty in arranging lodging.

For the preceding reasons, the economic interests of the sponsor 24 constrain it to consider auditing how many of the event's registrants actually obtain lodging within the block committed by the hotels 26a-26d. While those who collaborate in organizing this type of event generally guess that about 20% to 30% of an event's registrants book room reservations outside the blocks committed by the hotels 26a-26d, auditing the guest lists of the hotels 26a-26d is the only way that the sponsor 24 can prove that it met the contractually required minimum amount of room-nights. Auditing the guest lists of the hotels 26a-26d is also used by sponsors 24 in assessing the event's economic impact. This impetus to audit how many of the event's registrants actually obtain lodging within the block committed by each of the hotels 26a-26d has been increasing due to the ease with which reservations may now be made using the Internet. Sponsors 24 are becoming increasingly concerned that there exists a high probability that a significant number of lodging registrations are not being placed through the housing provider 32 because an event's registrants book their room reservation outside of the block using the Internet.

Presently, sponsors 24 have no way of determining who books a reservation around or outside of the housing provider 32. A recent survey of sponsors 24 identified attrition payments as the most significant problem in event housing. The second most important issue was the trend for registrants to make room reservations outside the block. Sponsors 24 concerns about the impact on-line booking services are having on their room blocks include attrition penalties, reduced ancillary benefits, and loss of priority positioning for space and dates in many prime event venues.

Consequently, in an attempt to determine if registrants have booked lodging with the hotels 26a-26d outside of the service provided by the housing provider 32, recently E24s˜ have begun including clauses in their contracts with hotels 26a-26d which permit the sponsor 24 to audit the hotel's guest list during the block. Mainly, the hotels 26a-26d are accepting such clauses in their contracts with sponsors 24. Thus, auditing hotels guest lists by sponsors 24 is gaining momentum if for no other reasons than as an assurance that the sponsor 24 will avoid being compelled to pay unwarranted attrition charges, and/or losing ancillary benefits.

Whenever a sponsor 24 compels an audit, it is generally directed only at those hotels 26a-26d having attrition clauses in their contracts. In such instances, the audit's main motivation is to mitigate attrition payments and/or to justify receipt of ancillary benefits by the sponsor 24. In discharging their obligations under an audit clause, some hotels 26a-26d will agree to release their in-house guest lists if the auditor signs a confidentiality agreement. However, such auditing arrangements are becoming progressively more difficult to obtain because of increasing confidentiality concerns. Furthermore, some major chain hotels 26a-26d refuse to provide access to their in-house guest list under any circumstances. When a hotel 26a-26d refuses to release their in-house guest list to an outside auditor, then the staff in the group reservations department of the hotel 26a-26d generally performs the audit. Regardless of how the audit is handled, the hotels 26a-26d are asked to review each guest's name that matches the name of an event registrant to verify that the name truly represents a separate room occupancy, and is not a guest who shared a room with a different registrant. After the hotels 26a-26d complete their review and verify the audit's accuracy, the information is compiled into a report that is sent to the event's sponsor 24.

There exist various different methods for conducting a housing audit. Some hotels 26a-26d require that the audit be conducted on their premises even if in-house personnel are not conducting the audit. At an opposite extreme, some hotels 26a-26d furnish their in-house guest list in the form of a machine readable spreadsheet, and allow the audit to be performed off-site. Regardless of where an audit is performed or the formats of the registrants list and of the in-house guest list, an audit usually consists in manually matching names of registrants appearing in the event's registration list with names appearing on the in-house guest list. Manual audits usually involve employees of the hotel 26a-26d and of the auditor meeting face-to-face to review the registration and guest lists. When a pair of names match, the hotel 26a-26d then researches the name to verify that the person represents an actual paid room occupancy, and is not a share-with attached to a primary reservation holder. Performing audits manually is cumbersome, with the initial name matching part of the audit being both time-consuming and labor-intensive. After the audit meeting, its results then have to be manually compiled into a final report. Errors and omissions occur easily as a consequence of this manual process. Furthermore, the expense of conducting housing audits is significant and growing.

Because of the time and expense involved in conducting an audit, typically only rooms occupied on the peak night of an event are audited otherwise the process would have to be repeated for each night in the room block. However, even auditing rooms occupied on the peak night of an event can be a herculean task when, as sometimes occurs, the registrants list occupies more than 6,000 pages. Furthermore, current manual audits fail to provide any insight into why registrants book lodging outside of the block.

Relationships existing between the sponsor 24 and the CVB 42, and between the CVB 42 and the hotels 26a-26d provide additional incentives for auditing room occupancy by an event's registrants. Usually, confirming with the CVB 42 dates and space at a city's convention center requires a minimum peak night occupancy. If occupancy falls below the required minimum, the sponsor 24 often receives “tentative” dates with the CVB 42 reserving a right to move the event to other dates if the CVB 42 receives a better proposal from another sponsor 24. While a CVB 42 is unlikely to conduct an audit itself or to even participate in an audit, an audit can benefit the CVB 42 economically since funding for the CVB 42 generally represents some fraction of room tax revenues attributable to the CVB's activities. The arrows 44a-44d in the block diagram of FIG. 1 indicate this funding accruing to the CVB 42 from the hotels 26a-26d.

### BRIEF SUMMARY

An object of the present disclosure is to provide a more accurate assessment of occupancy at hotels in the sponsor's room block.

Another object of the present disclosure is to provide faster and easier housing audits.

Another object of the present disclosure is to provide less expensive housing audits.

Yet another object of the present disclosure is to provide housing audits that impose minimal changes to the hotel's established work processes.

Yet another object of the present disclosure is to provide housing audits without requiring face to face meetings.

Yet another object of the present disclosure is to provide housing audits for which decisions can be made by more senior hotel personnel.

Yet another object of the present disclosure is to provide housing audits in which the information underlying audit decisions is apparent and more complete.

Yet another object of the present disclosure is to provide housing audits in which each match between the registrant and guest lists indicates whether it has been validated and accepted by the hotel as being genuine.

Yet another object of the present disclosure is to provide more accurate housing audits.

Yet another object of the present disclosure is to provide housing audits which assure confidentiality.

Yet another object of the present disclosure is to provide housing audits in which the sponsor and hotels possess better control and receive more information.

Yet another object of the present disclosure is to provide increased understanding of how, when, and why registrants book rooms outside the sponsor's block.

Yet another object of the present disclosure is to reduce out-of-block room bookings, and to better estimate the size of future block commitments.

Yet another object of the present disclosure is to provide housing audits which are capable of furnishing additional marketing information.

Briefly, the present disclosure includes a method by which a sponsor audits temporary housing occupied by registrants while attending an event located in a geographical region. Before the event the sponsor performs steps of:

a. arranging a commitment with at least one hotel to reserve for booking via the sponsor a number of rooms during a block of dates thereby making the block of rooms available for occupancy by registrants while attending the event; and

b. arranging with a housing provider to mediate between registrants for the event and the at least one hotel in booking reservations for lodging registrants attending the event.

The auditing method includes steps of:

a. producing using a computer an out-of-block list, that contains records which identify registrants who may have booked lodging outside the block of rooms committed by at least one hotel, by deleting from a machine-readable registrant list, that contains records which identify registrants for the event, those records which identify an individual who is also identified in a machine-readable in-block list, that contains records which identify attendees who have booked lodging through the housing provider;

b. storing the out-of-block list on a housing-audit server;

c. producing using a computer a match list, that contains records which identify registrants who have booked lodging with at least one hotel outside the block of rooms, by matching records in the out-of-block list with records in a machine-readable guest list prepared by the hotel, that contains records which identify guests who have booked lodging with the hotel;

e. storing the match list on the housing-audit server; and

f. transmitting from the housing-audit server to the sponsor a report which correlates records in the out-of-block list with records in the match list.

The present disclosure also includes a housing-audit server adapted for use by a sponsor in auditing temporary housing occupied by registrants while attending an event located in a geographical region. The housing-audit server includes:

a. storage for the out-of-block list;

b. storage for the match list(s); and

c. transmission of a report which correlates records in the out-of-block list with records in the match list to the sponsor.

These and other features, objects and advantages will be understood or apparent to those of ordinary skill in the art from the following detailed description of the preferred embodiment as illustrated in the various drawing figures.

### BRIEF DESCRIPTION OF THE DRAWINGS

FIG. 1 is an overall functional-type block diagram depicting relationships existing among an event's sponsor, various hotels, a housing provider, and a CVB;

FIG. 2 is an overall functional-type block diagram depicting information flow among various computers forming a system for efficiently and securely auditing event housing;

FIG. 3 is an overall functional-type block diagram depicting processing of a sponsor's registrants list and a housing provider's in-block list performed at a sponsor's computer in producing an out-of-block list and up-loading the out-of-block list to a housing-audit server;

FIG. 4 depicts a display of the out-of-block list appearing at the sponsor's computer;

FIG. 5 is a functional-type block diagram depicting information flow and processing within the housing-audit server which mediates information sharing between a sponsor's computer and individual computers of various hotels;

FIG. 6 is an overall functional-type block diagram depicting processing of the out-of-block list and the hotel's guest-list performed at a hotel's computer in producing a hotel's match list and up-loading the match list to the housing-audit server;

FIG. 7 depicts a display of the audit match results appearing at the hotel's computer for review and validation in producing the hotel's match list;

FIG. 8 illustrates a relationship existing between FIGS. 8A and 8B, the combined FIGS. 8A and 8B forming a detailed flow chart depicting record matching between the sponsor's registration list and the housing provider's in-block list performed at the sponsor's computer in producing the out-of-block list;

FIG. 9 illustrates a relationship existing between FIGS. 9A and 9B, the combined FIGS. 9A and 9B forming a detailed flow chart depicting record matching between the out-of-block list and the hotel's guest-list performed at the hotel's computer in producing the hotel's match list; and

FIG. 10 depicts a summary, final audit report delivered to the sponsor.

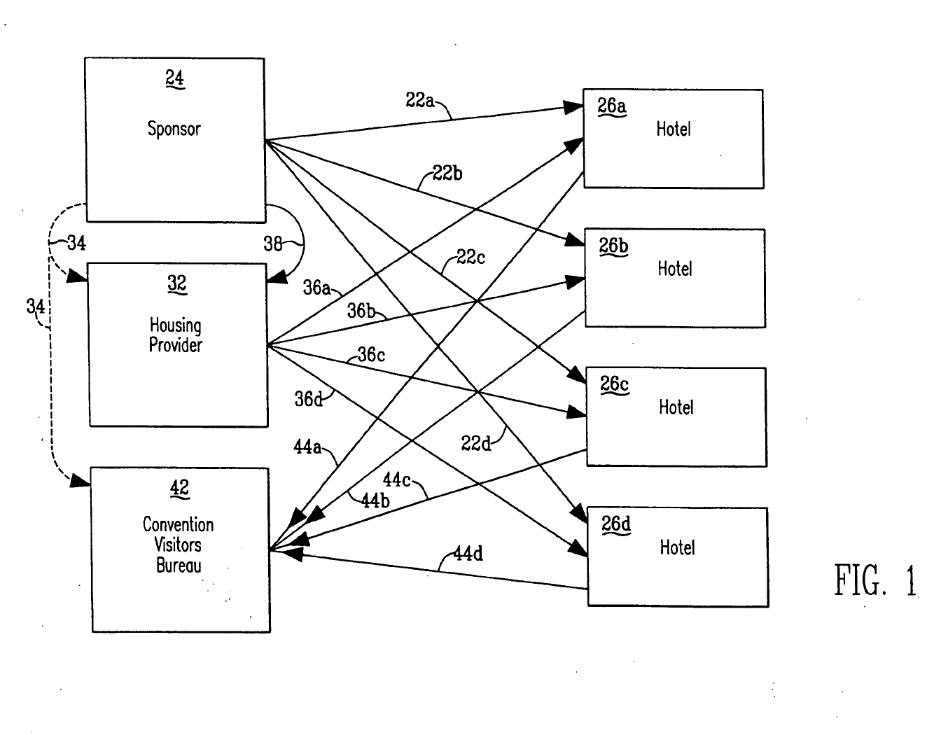

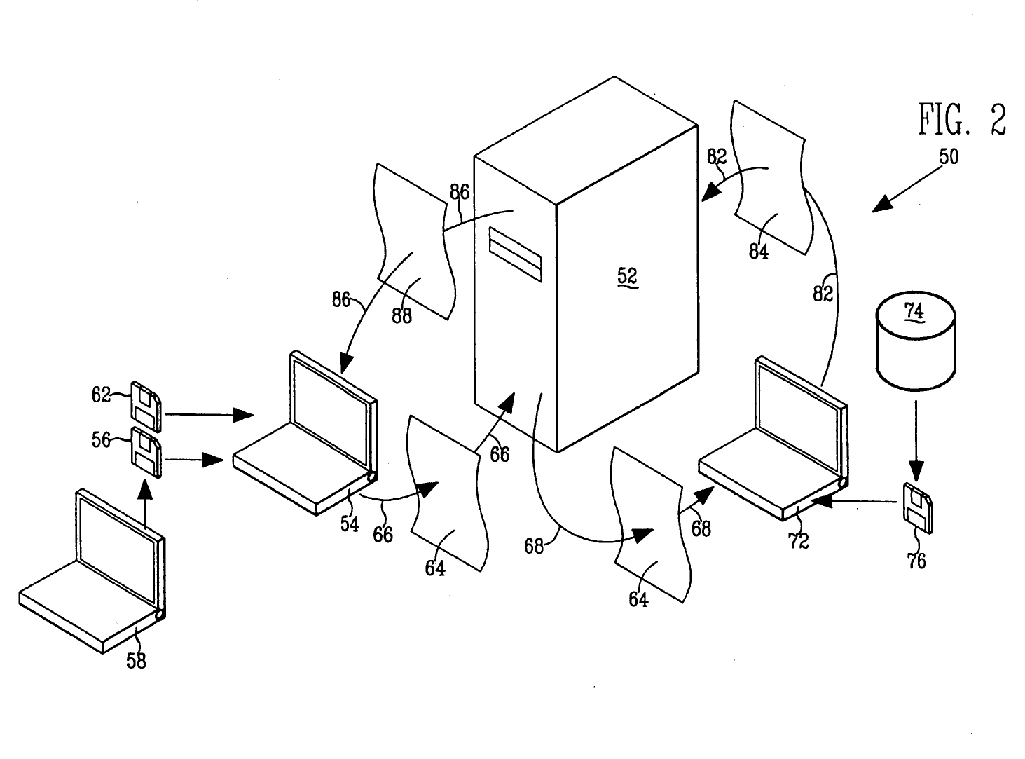

### DETAILED DESCRIPTION

The overall functional-type block diagram of FIG. 2 depicts information flow within a housing audit system in accordance with the present disclosure referred to by the general reference character 50. When the sponsor 24 decides that registrant housing for an event will be audited, the sponsor 24 must prepare the housing audit system 50 for conducting the audit by initializing a housing-audit server 52 included in the housing audit system 50. Preferably, the housing-audit server 52 will be initialized for performing an audit well in advance of an event so the hotels 26a-26d will be notified so there is ample time to save to a file on their computer their in-house guest list for at least the peak night. To provide a more accurate and comprehensive audit, preferably the hotels 26a-26d will save files of their in-house guest lists for all nights in the block.

In initializing the housing-audit server 52 for auditing the event, the sponsor 24 preferably accesses the housing-audit server 52 via the Internet to establish an audit account for the event. The housing-audit server 52 responds to such an access by providing a guided dialog between the housing-audit server 52 and a sponsor's computer 54. The dialog provided by the housing-audit server 52 prompts for entry of various data pertinent to the audit listed below.

1. The name of the sponsor 24

2. The event's name

3. The date of the peak night anticipated for the event

4. The name, full address, telephone number and E-mail address of an individual who can be contacted on behalf of the sponsor 24 regarding the event and the audit

5. The number of hotels 26a-26d to be audited

6. A password to be used subsequently by the sponsor in communicating with the housing-audit server 52 regarding the audit via the Internet

After the sponsor's computer 54 dispatches the preceding information, the housing-audit server 52 establishes an account for auditing the event, and issues the sponsor 24 a unique event ID to be used when subsequently accessing the housing-audit server 52.

After receiving the event ID, using both the event ID and the previously entered password the sponsor's computer 54 logs onto the housing-audit server 52 a second time to enter information about each of the hotels 26a-26d to be audited into the event account. During a second guided dialog the sponsor 24 repetitively enters the following information for each of the hotels 26a-26d.

1. The name of the hotel 26a-26d

2. The name and E-mail address of an individual who can be contacted on behalf of the hotel 26a-26d regarding the audit.

Shortly before the event's scheduled dates, the housing-audit server 52 dispatches E-mails to the contact individual identified for each of the hotels 26a-26d. The E-mail informs the contact individual that they are to use the housing-audit server 52 in performing an audit for the specified event. The E-mail specifies the requirements for using the housing-audit server 52, and explains the first steps to be performed by the hotel 26a-26d. The E-mail also includes a unique user ID and a unique password that the hotel 26a-26d must use when communicating with the housing-audit server 52.

After the housing-audit server 52 has been initialized, performing the housing audit requires that the housing provider 32 first prepare a machine-readable registrant in-block list 56 using a housing-provider's computer 58, and then furnish the in-block list 56 to the sponsor 24. The sponsor 24 then enters its machine-readable registrant list 62 which identifies individuals attending the event together with the in-block list 56 into the sponsor's computer 54. Within the sponsor's computer 54, a computer program matches registrants appearing in the registrant list 62 with hotel guests appearing in the in-block list 56 to produce a list 64 of registrants who may have made room reservations outside the blocks of rooms committed respectively by the hotels 26a-26d. Prepared in this way the out-of-block list 64 includes only names appearing in the registrant list 62 which do not appear in the in-block list 56. Having produced the out-of-block list 64, as indicated by a curved arrow 66 the sponsor 24 then uploads the out-of-block list 64 into the housing-audit server 52 for storage there.

In discharging its contractual housing audit obligation, as indicated by a curved arrow 68 in FIG. 2 each hotel 26a-26d individually downloads a copy of the out-of-block list 64 from the housing-audit server 52 into its hotel's computer 72. Using guest data stored its project management system (“PMS”) 74, the hotel 26a-26d prepares a machine-readable guest list 76 at least for the peak night of the event, or for all nights in the event's block, for entry into the hotel's computer 72. Within the hotel's computer 72, a computer program matches names appearing in the guest list 76 with event registrants identified in the out-of-block list 64 to determine which guests might be out-of-block event registrants. As indicated by a curved arrow 82, the unvalidated match list 84 produced by the computer program can be uploaded immediately to the housing-audit server 52 for subsequent down-loading, validation and acceptance by hotel personnel. Alternatively, the match list 84 may be validated and accepted immediately by hotel personnel before uploading to the housing-audit server 52. During validation and acceptance the computer program displays for hotel personnel review a list that contains only those guests which might be out-of-block event registrants. Hotel personnel then individually examine each match between the out-of-block list 64 and the guest list 76 which permits the hotel 26a-26d to validate and accept individual matches as being a genuine event registrant who made an out-of-block room reservation.

Having identified those guests who are genuinely an event registrant who made an out-of-block room reservation and having uploaded their respective match lists 84 to the housing-audit server 52, as indicated by a curved arrow 86 the sponsor 24 can download various different audit reports 88 for the event from the housing-audit server 52 into the sponsor's computer 54. Initially, audit reports 88 are available for only those hotels 26a-26d that have completed their audit and uploaded their respective match lists 84. One of the audit reports 88 which the sponsor 24 can download arrives in a structured format that can be read using a text editor or loaded into Microsoft Corporation's Excel spread-sheet computer program. Via the clipboard of the sponsor's computer 54, data in this type of audit report 88 can be copied into an Excel spreadsheet. When all the hotels 26a-26d have completed their audits and uploaded their respective match lists 84, the housing-audit server 52 can also generate a final audit report 88 which summarizes data for all of the sponsor's room blocks being audited. The housing-audit server 52 preferably presents the final audit report 88 to the sponsor 24 in Adobe Acrobat PDF format.

Description of Software

Computer programs executed by digital computers implement the current embodiment of the disclosure. Appendix I provides a source code program listing for an implementation of this embodiment. It is readily apparent to those skilled in the art that various other programming languages and/or digital computers could be used for alternative, equivalent implementations of the disclosure.

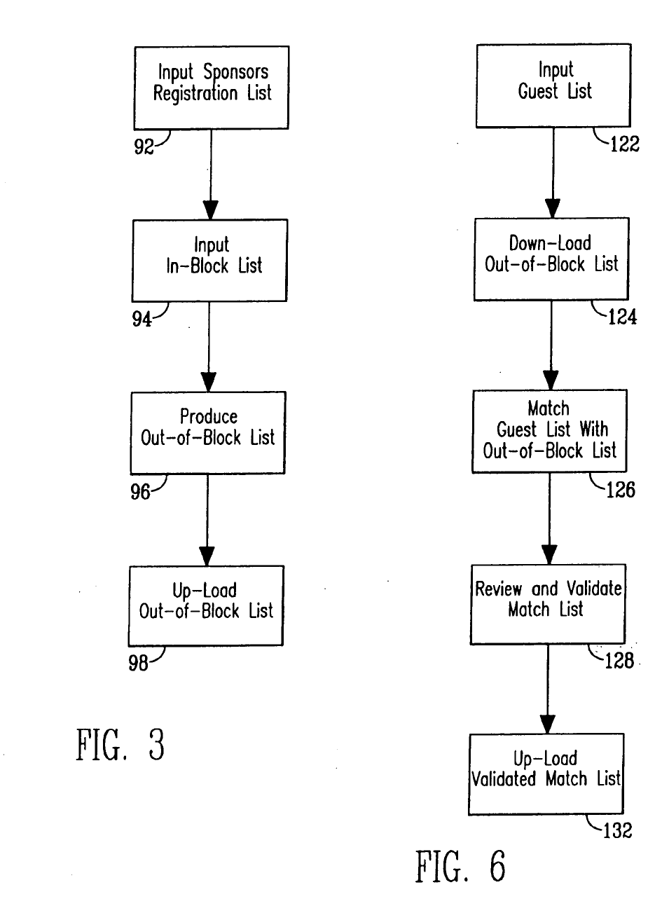

The overall functional-type block diagram of FIG. 3 depicts a portion of the computer program for processing of the in-block list 56 and the registrant list 62 within the sponsor's computer 54 to produce the out-of-block list 64. Production of the out-of-block list 64 in the sponsor's computer 54 begins in block 92 with inputting of the sponsor's registrant list 62. Immediately thereafter, the in-block list 56 furnished by the housing provider 32 is input to the sponsor's computer 54 in block 94. While in principle the sponsor's computer 54 could accept the registrant list 62 and the in-block list 56 in any machine-readable format, for simplicity and convenience a preferred embodiment of the computer program for the sponsor's computer 54 accepts the registrant list 62 and the in-block list 56 formatted as a comma separated values (“CSV”) file.

A CSV formatted file is a text file in which each row of text represents a different data record analogous to a horizontal row in a spreadsheet, for example, all the information for a single registrant. Within each row of text, individual data items are separated by commas into columns analogous to spreadsheet column. In the CSV formatted file, each row of text has the same number of columns and the same type of information in each column. If initially the registrant list 62 and/or the in-block list 56 were available in some other machine readable format such as a Microsoft Corporation Excel spreadsheet, the spreadsheet computer program may be used for preparing a CSV formatted file.

The following table illustrates the format of a CSV file with each data item in a separate column extending from left to right respectively containing a first name, a last name, a city, a state and a zip code. This example also includes a heading row shown in capital letters which identifies each column.

FIRST NAME,LAST NAME,CITY,STATE,ZIP
Kathy,Jones,Wilmington,MA,01887
Linda,De Salvo,San Jose,CA,94112
Michael,Murphy,Billerica,CA,95134
Robert,“Jones, Jr.”,Palo Alto,CA,94043

Note that comma is used to separate each column of data. However, if the data in a particular column of a CSV format record includes a comma, e.g. Jones, Jr., that data item is enclosed within quotation marks to indicate that the comma does not indicate a column separation but rather is part of the data. For example: “Jones, Jr.” indicates that the comma between Jones and Jr. is part of the last name and therefore all the characters enclosed within the quotation marks belongs to a single column.

The registrant list 62 preferably includes the data items listed below in the columns of every record in the machine-readable CSV file. Preferably, the order of the columns does not matter, and the records may include additional columns.

| | |
|---|---|
| (Required) | Registrant's last name |
| (Required) | Registrant's first name |
| (Required) | Registrant's City |
| (Required) | Registrant's Zip code or postal code |
| (Optional) | Registrant's Phone number |
| (Optional) | Registrant's Company |
| (Optional) | Registrant's E-mail address |

The in-block list 56 preferably includes the data items listed below in the columns of every record in the machine-readable CSV file. Preferably, the order of the columns does not matter, and the records may include additional columns.

| | |
|---|---|
| (Required) | In-block registrant's last name |
| (Required) | In-block registrant's first name |
| (Required) | In-block registrant's City |
| (Required) | In-block registrant's Zip code or postal code |
| (Optional) | In-block registrant's Phone number |
| (Optional) | In-block registrant's Company |
| (Optional) | In-block registrant's E-mail address |

Including E-mail address and other optional information in the registrant list 62 and the in-block list 56 increases the accuracy of the audit match results thereby significantly reducing the amount of time required for personnel of the hotel 26a-26d to validate and accept individual matches in the match list 84.

The computer program executed by the sponsor's computer 54 preferably requires labeling the type of data appearing in each column of the records before inputting the registrant list 62 and the in-block list 56. Preferably the computer program permits assigning an “IGNORE” data type to individual columns in the records. Assigning an “IGNORE” data type to individual columns avoids any need to remove surplus data appearing in the registrant list 62 and/or in the in-block list 56 before inputting them into the sponsor's computer 54. For sponsors 24, surplus data appearing in the registrant list 62 might include a member number, paid status, booth number, chapter affiliations, etc. By appropriately labeling columns containing such unneeded data “IGNORE,” in inputting the registrant list 62 and/or the in-block list 56 into the sponsor's computer 54 the computer program skips over and ignores data appearing in those columns. Since data in columns labeled as “IGNORE” is not needed in conducting the audit, it is therefore preferably omitted from the out-of-block list 64 uploaded to the housing-audit server 52.

The computer program which produces the out-of-block list 64 requires a machine-readable CSV file containing the in-block list 56. If such a file does not exist or is unavailable, the computer program can still produce a out-of-block list 64 for use by the hotels 26a-26d. If such a circumstance occurs, the computer program will accept an empty file for the in-block list 56. An empty file can be prepared by opening any text editor such as Microsoft Corporation's Notepad or Word computer programs, and saving an empty file as a plain text file, i.e. a file with a *.txt or *.csv file extension, not as formatted document, e.g. a file with a *.doc or *.rtf file extension. To avoid having registrants who booked within the event housing block from appearing in the match list 84, if no in-block list 56 exists the hotels 26a-26d must generate a guest list 76 that excludes names of all guests who were booked into event housing block by the housing provider 32. The PMS 74 used by most hotels 26a-26d possess a capability for preparing such a guest list 76 by filtering on a “group code” assigned to the event.

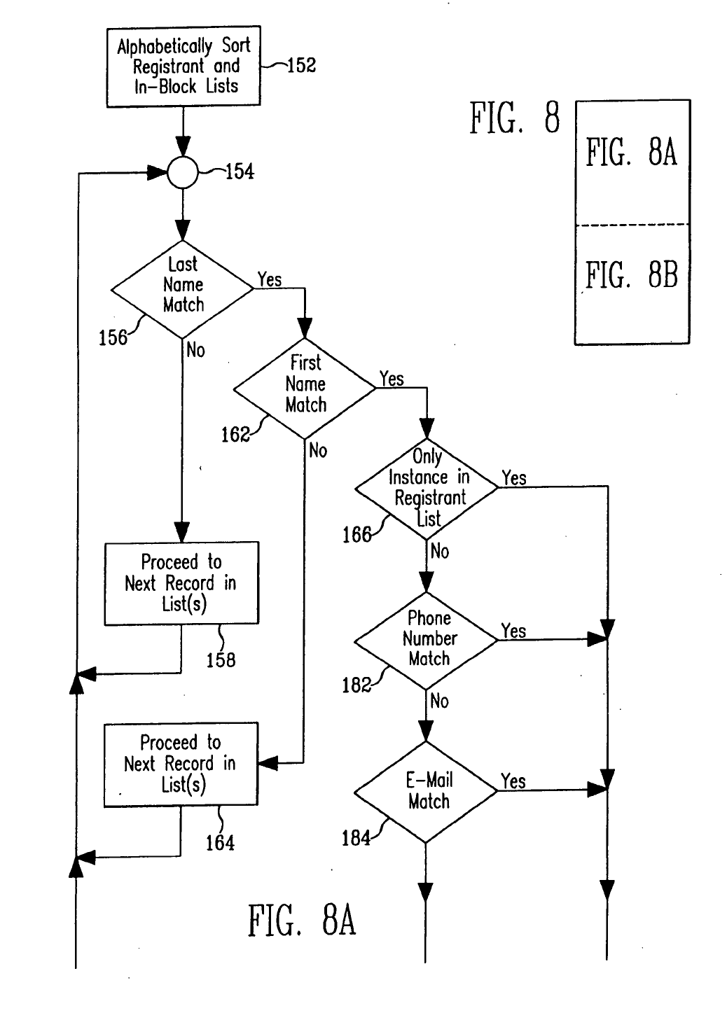

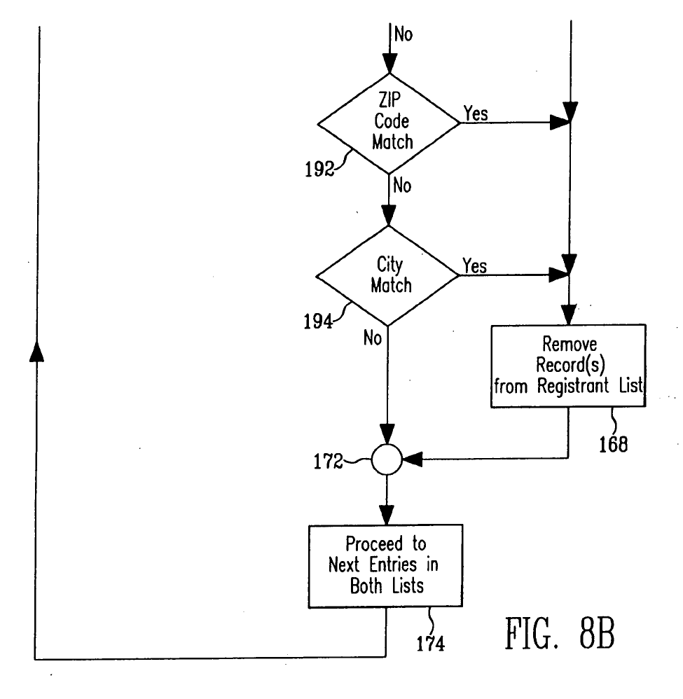

After being input into the sponsor's computer 54, in block 96 of FIG. 3 records in the registrant list 62 and the in-block list 56 are then matched to omit from the out-of-block list 64 all records in the registrant list 62 which appear in the in-block list 56. (A more detailed explanation of how records in the registrant list 62 and the in-block list 56 are matched appears below in connection with a description of FIGS. 8A and 8B.) FIG. 4 depicts a display of the out-of-block list appearing at the sponsor's computer 54 after matching the registrant list 62 and the in-block list 56. Finally, in block 98 the sponsor's computer 54 uploads the out-of-block list 64 to the housing-audit server 52.

When the out-of-block list 64 has been uploaded to housing-audit server 52, the hotels 26a-26d receive an E-mail containing a unique login ID and password that advises them to conduct the audit. Furthermore, after the out-of-block list 64 has been uploaded to housing-audit server 52 the sponsor 24 can logon to the housing-audit server 52 to ascertain the status of the audit's progress. Responsive to such an inquiry, the housing-audit server 52 provides the sponsor 24 with a list of the hotels 26a-26d annotated to indicate the status for compiling the match list 84 by each hotel 26a-26d.

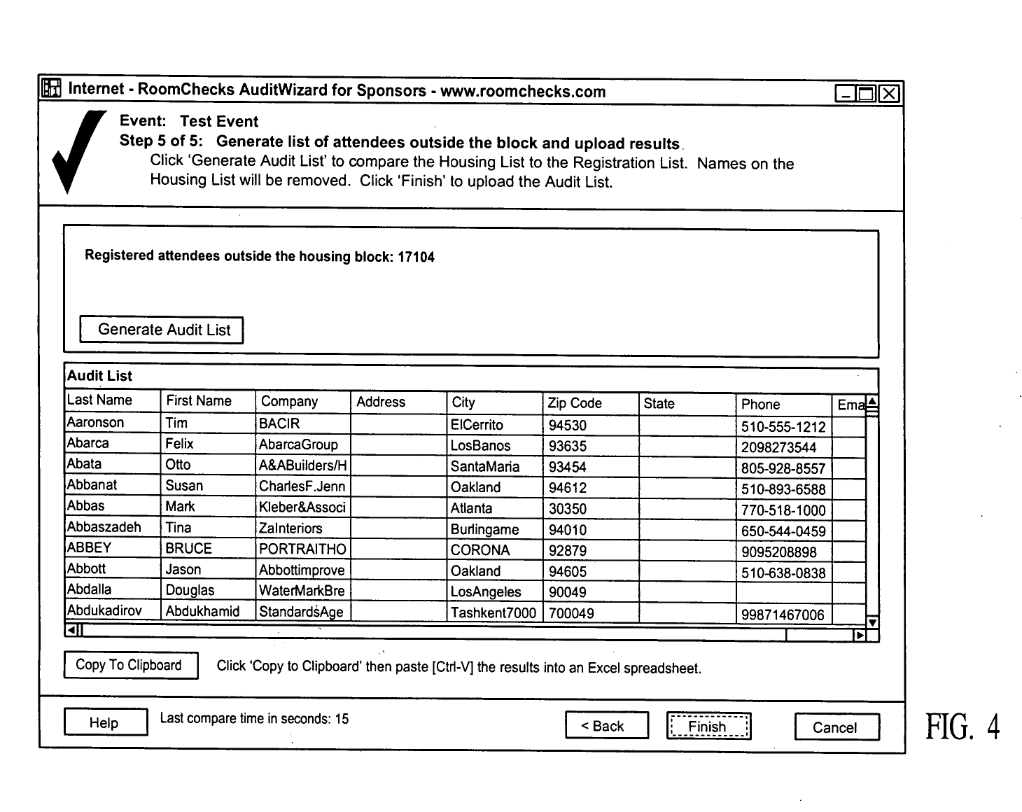

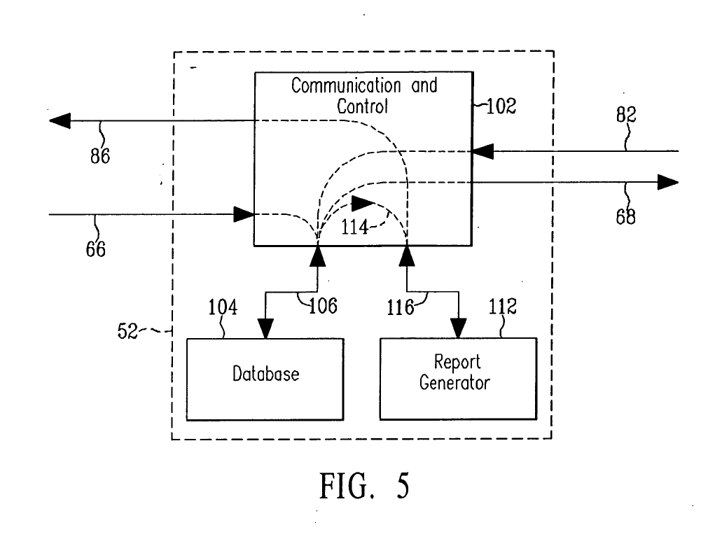

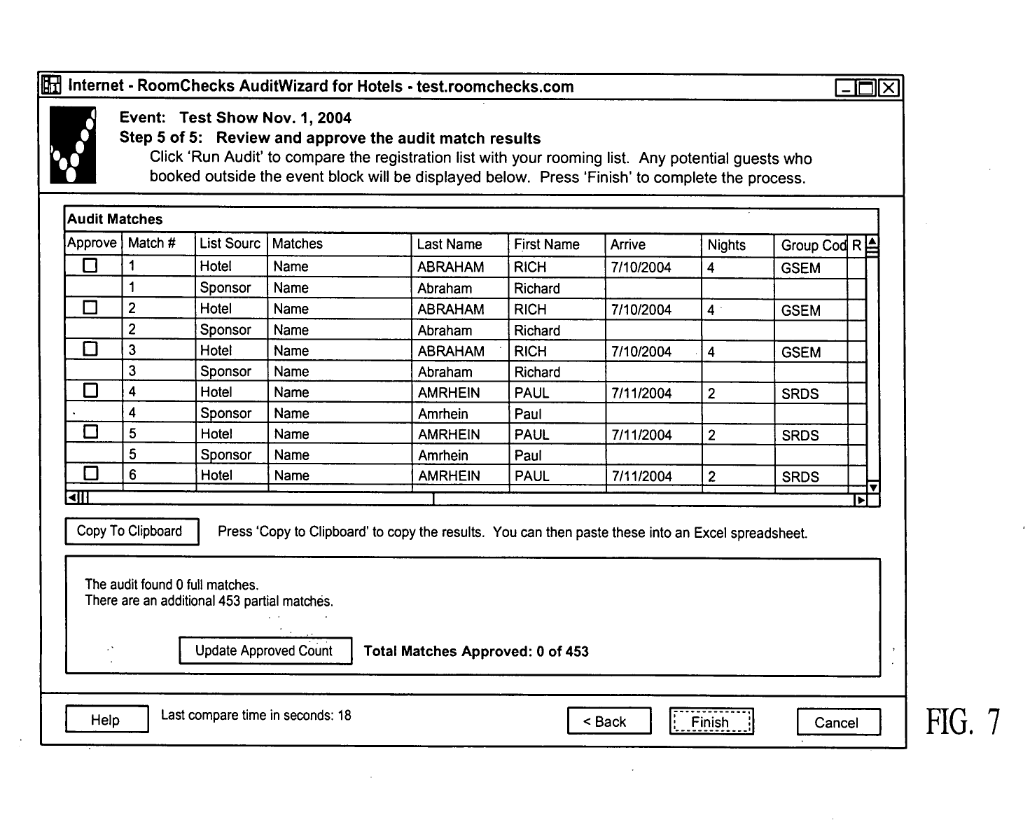

The functional-type block diagram of FIG. 5 depicts information flow and processing within the housing-audit server 52. The arrow 66 depicts receipt of the out-of-block list 64 by a communication and control module 102 included in the housing-audit server 52. Upon receiving the out-of-block list 64 from the sponsor's computer 54, the module 102 stores the out-of-block list 64 into a database 104 indicated by a double-headed arrow 106. Subsequently, when a hotel 26a-26d logs onto the housing-audit server 52 the module 102 retrieves a copy of the out-of-block list 64 from the database 104 for transmission to the hotel 26a-26d as indicated by the arrow 68. Analogous to processing of the out-of-block list 64, the module 102 stores the match list 84 into the database 104 upon its arrival from the hotel's computer 72 as indicated by the arrow 82. When the sponsor's computer 54 logs onto the housing-audit server 52 requesting a housing audit report, the module 102 retrieves from the database 104 copies of the match lists 84 compiled by the various hotels 26a-26d, and supplies them to a report generator 112 as indicated by a curved arrow 114 and a double-headed arrow 116. After the report generator 112 using the match lists 84 prepares an audit report, the module 102 retrieves the report from the report generator 112 for transmission to the sponsor's computer 54 as indicated to the arrow 86. Preferably, the database 104 is implemented using Microsoft Corporation's SQL Server relational database computer program, and the report generator 112 is implemented using a computer program named “Active Reports for .NET” which is available from Data Dynamics of Columbus, Ohio.

The overall functional-type block diagram of FIG. 6 depicts processing of the out-of-block list 64 and the guest list 76 within the hotel's computer 72 to produce the match list 84. Production of the match list 84 in the hotel's computer 72 begins in block 122 with inputting of the hotel's guest list 76. While in principle the hotel's computer 72 could accept the guest list 76 in any machine-readable format, for simplicity and convenience a preferred embodiment of the computer program for the hotel's computer 72 accepts the guest list 76 formatted as a CSV file. The characteristics of a CSV file are described above in connection with FIG. 3's inputting of the registrant list 62 and the in-block list 56. The following table lists data preferably included in the guest list 76.

| | |
|---|---|
| (Required) | Guest's last name |
| (Required) | Guest's first name |
| (Required) | Guest's City |
| (Required) | Guest's Zip code or postal code |
| (Optional) | Guest's Phone number |
| (Optional) | Guest's Company Name |
| (Optional) | Guest's E-mail address |
| (Required) | Guest's Date of Arrival (in MM/DD/YY format) |
| (Required) | Either one or the other of the following: |
| | Guest's Number of nights of stay |
| | Guest's Date of Departure (in MM/DD/YY format) |
| (Preferred) | Room Number |
| | (The room number facilitates matching guests sharing a room |
| | so they are not counted twice.) |
| (Optional) | Reservation Source (e.g., travel agent, e-channel, 800 number, |
| | walk-up, etc.) |
| (Optional) | Room Rate |
| (Optional) | Room Type |
| (Optional) | Reservation ID |
| | (This is not a guest ID, but an identifier that is the same for all |
| | guests on the same reservation. The Reservation ID facilitates |
| | matching guests sharing a room so they are not counted |
| | twice.) |
| (Optional) | Date Reservation Made (in MM/DD/YY format) |

Including the optional E-mail address, phone number and company name information in the guest list 76 increases the accuracy of the audit match results. Analogously, the optional reservation source, reservation ID and particularly room number facilitate identifying guests who share a room so they are not counted twice. Both types of optional data significantly reduces the amount of time required for personnel of the hotel 26a-26d to validate and accept individual matches in the match list 84. Including optional guest information in the guest list 76 helps ensure that matches are valid. For common names that appear both in the out-of-block list 64 and in the guest list 76, including the zip code, company name, and phone number will either confirm the name match or rule it out. Including optional reservation source, reservation date, room type and room rate provide additional information helps both the hotel 26a-26d and the sponsor 24 to better understand decision-making behavior that prompts booking outside the event's housing block. Preferably, no optional guest information included in the guest list 76 appears in the match list 84.

Similar to the computer program executed by the sponsor's computer 54, the computer program executed by the hotel's computer 72 preferably requires labeling the type of data appearing in each column of the records before inputting the guest list 76. Preferably the computer program permits assigning an “IGNORE” data type to individual columns in the records. Assigning an “IGNORE” data type to individual columns avoids any need to remove surplus data appearing in the guest list 76 before inputting it into the hotel's computer 72. For hotels 26a-26d, surplus data appearing in the guest list 76 might include market code, group code, or other internal data, etc. By appropriately labeling columns containing such unneeded data “IGNORE,” in inputting the guest list 76 into the hotel's computer 72 the computer program skips over and ignores data appearing in those columns. Since data in columns labeled as “IGNORE” is not needed in conducting the audit, it is therefore preferably omitted from the match list 84 uploaded to the housing-audit server 52.

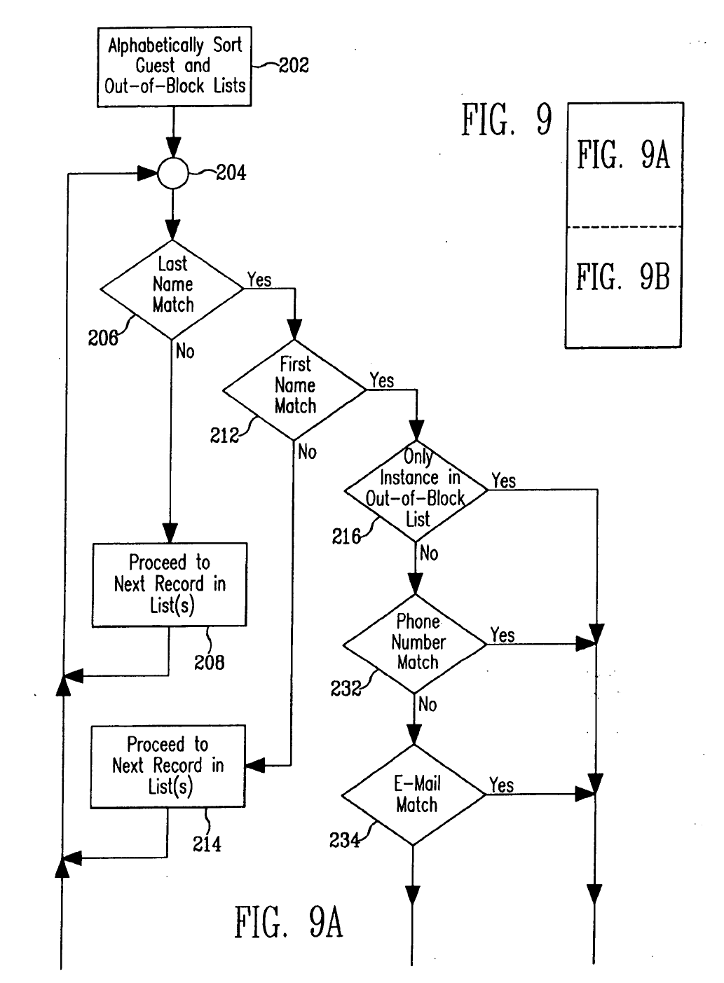

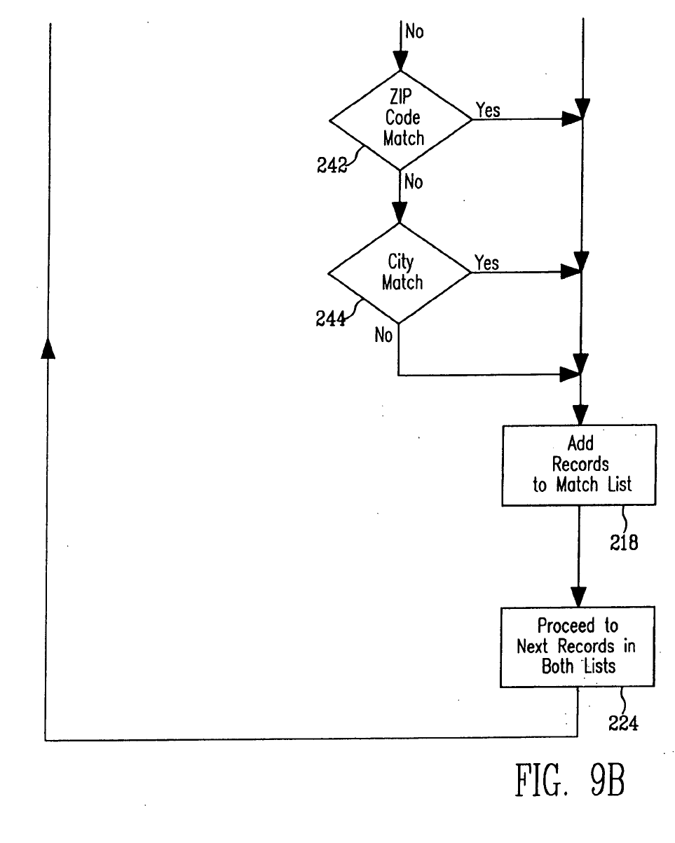

After the hotel's computer 72 inputs the guest list 76, it downloads the out-of-block list 64 from the housing-audit server 52 as indicated in block 124 of FIG. 6. With both the guest list 76 and the out-of-block list 64 now in the hotel's computer 72, in block 126 records in the guest list 76 and the out-of-block list 64 are matched to correlate all records in the out-of-block list 64 which appear in the guest list 76. (A more detailed explanation of how records in the out-of-block list 64 and the guest list 76 are matched appears below in connection with a description of FIGS. 9A and 9B.)

After the computer program executed by the hotel's computer 72 completes matching records in the guest list 76 and the out-of-block list 64, in block 128 a report of possible name matches appears on the hotel's computer 72. FIG. 7 depicts a display of the match list appearing at the hotel's computer 72 after matching the out-of-block list 64 and the guest list 76. To expedite the verification process, the match report appearing on the hotel's computer 72 preferably shows match criteria for each name, both the registration data from the out-of-block list 64 and the guest data from the guest list 76. The displayed match report preferably further emphasizes those parts of data that match between the out-of-block list 64 and the guest list 76. Preferably, the match list 84 is formatted so it can be read using a text editor or the Microsoft Corporation's Excel spreadsheet computer program. Preferably, this report can be copied into the clipboard of the hotel's computer 72 to be saved or printed later. After reviewing the match criteria for each name appearing in the match report, personnel of the hotel 26a-26d validate the genuine matches. The validation process allows the hotel 26a-26d to indicate which of the name matches are acceptable, and which of the matches are rejected. Finally, in block 132 the hotel's computer 72 uploads the match list 84 to the housing-audit server 52.

Note that all data processing depicted in the block diagrams of FIGS. 3, 5 and 6 can be performed retrospectively after the event closes. Since attendee registration generally continues during events, the processing depicted in FIGS. 3, 5 and 6, in many instances, will actually be performed later.

Producing the
Out-of-Block List 64

A detailed flow chart formed by combining FIGS. 8A and 8B depicts the preferred process, performed by the sponsor's computer 54, for matching records between the sponsor's registrant list 62 and the housing provider's in-block list 56. When records in the lists 62 and 56 match, to produce the out-of-block list 64 the matching record is omitted from the out-of-block list 64. The out-of-block list 64 obtained in this way contains only those records that appear in the registrant list 62 for which the computer program identifies no matching record in the in-block list 56.

Initial matching between records in the lists 62 and 56 relies upon last name and first names in a pair of records selected from the lists 62 and 56. The computer program executed by the sponsor's computer 54 uses additional information including optional information, such as city, Zip or postal code, phone number, and E-mail address, for resolving matches between a name appearing in the in-block list 56 and several similar names appearing in the registrant list 62 thereby avoiding false matches. Matching pairs of records in the lists 62 and 56 is intended to err in favor of including a record from the registrant list 62 in the out-of-block list 64. If a record is erroneously included in the out-of-block list 64, presumably personnel employed by the hotel 26a-26d will note the error while validating and accepting individual matches during their inspection of the match list 84.

Before inputting the registrant list 62 into the sponsor's computer 54 depicted in block 92 of FIG. 3, to improve audit accuracy preferably sponsor personnel review the registrant list 62 to ensure that it lacks duplicate records, and to the maximum extent practicable includes complete data for every registrant. Matching records between the registrant list 62 and the in-block list 56 depicted in block 96 of FIG. 3 begins in block 152 of FIG. 8A with sorting of both of the lists 62 and 56 by last name and first name, preferably in ascending order. Furthermore, to facilitate comparison data extracted from the pair of records is regularized such as removing all white space from data including last, first and company names, treat upper and lower case letters the same, and ignore punctuation.

The computer program executed by the sponsor's computer 54 then proceeds down the sorted lists 62 and 56 maintaining coordination between the last names and first names in records being compared. Proceeding through junction block 154, the computer program first determines in decision block 156 if the last names in a pair of records match exactly. If the last names do not match exactly, the computer program proceeds to block 158 to select another pair of records from the sorted lists 62 and 56 for comparison.

In block 158, selecting the next pair of records to be compared from the sorted lists 62 and 56 maintains alphabetic coordination between records in the lists 62 and 56. Thus, if the last name in the in-block list 56 is alphabetically below the last name in the registrant list 62, then the computer program selects the next record in the registrant list 62 for comparison with the currently selected name in the in-block list 56. Conversely, if the last name in the in-block list 56 is alphabetically above the last name in the registrant list 62, then the computer program selects the next record in the in-block list 56 for comparison with the currently selected name in the registrant list 62. After a new pair of records have been selected for comparison from the sorted lists 62 and 56, the computer program returns to the decision block 156 via the junction block 154.

If the last names in a pair of records match exactly, the computer program then determines in decision block 162 if the first names in the records match. However, differing from the exact matching required for last names, matching of first names uses only the first five (5) characters in the first names of both records. If either first name is shorter than five (5) characters, e.g. if one is simply an initial, the computer program executed by the sponsor's computer 54 requires that the two (2) first names match up to the length of the shorter of the names. If the last names match exactly but the first names do not match, the computer program proceeds to block 164 to select the next pair of records to be compared from each of the sorted lists 62 and 56.

Similar to block 158, in block 164 selecting the next pair of records to be compared from the sorted lists 62 and 56 maintains alphabetic coordination between records in the lists 62 and 56. Thus, if the first name in the in-block list 56 is alphabetically below the first name in the registrant list 62, then the computer program selects the next record in the registrant list 62 for comparison with the currently selected name in the in-block list 56. Conversely, if the first name in the in-block list 56 is alphabetically above the first name in the registrant list 62, then the computer program selects the next record in the in-block list 56 for comparison with the currently selected name in the registrant list 62. After a new pair of records have been selected for comparison from the sorted lists 62 and 56, the computer program returns to the decision block 156 via the junction block 154.

If the last and first names in a pair of records match as described above, the computer program then determines in decision block 166 if there exists only a single instance of the first and last names in the registrant list 62. If there exists only a single instance of the matching first and last names in the registrant list 62, then the computer program executed by the sponsor's computer 54 proceeds to block 168 for omitting the matched record from the out-of-block list 64. After omitting the matched record from the in-block list 56, then the computer program proceeds via junction block 172 to block 174. When block 174 is executed because there exists only a single instance of matching first and last names in the registrant list 62, the computer program:

1. selects the next records in each of the sorted lists 62 and 56 for comparison; and

2. returns to the decision block 156 via the junction block 154.

If the last and first names in a pair of records in the lists 62 and 56 match but there exists more than one instance of matching first and last names in the registrant list 62 and if an optional telephone number exists for the name-matching record in the in-block list 56, then for each matching name in the registrant list 62 having an optional telephone number the computer program determines in decision block 182 if the telephone numbers match. If telephone numbers in both lists 62 and 56 match for name-matching records, then the computer program proceeds to block 168 for further processing. When block 168 is executed because telephone numbers match between records in the lists 62 and 56, all records in the registrant list 62 which match last and first names and telephone number or E-mail address with the record from the in-block list 56 are omitted from the out-of-block list 64.

Before comparing a pair of telephone numbers, white space, parentheses, hyphens, and/or periods are removed from both numbers. If an alphabetic character occurs in the telephone number, presumably it precedes an extension number (e.g., “x 123” or “ext 123”). In comparing the pair of telephone numbers all strings of characters that begins with an alphabetic character are ignored. Telephone numbers match if the last seven digits of the phone number match exactly. For example, 1-950-331-7175 matches 950-331-7175 or just 331-7175.

If the last and first names in a pair of records in the lists 62 and 56 match but there exists more than one instance of matching first and last names in the registrant list 62 and telephone number matching fails and if an optional E-mail address exists for the name-matching record in the in-block list 56, then for each matching name in the registrant list 62 having an optional E-mail address the computer program determines in decision block 184 if the E-mail addresses match. Except for upper and lower case, E-mail addresses must match exactly. Thus, the E-mail address
“Richard.Thompson@RoomCHECKS.com” matches the E-mail address
“richard.thompson@roomchecks.com”, but does not match the E-mail address
“richardthompson@roomchecks.com” due to the period (.) omitted between “richard” and “thompson” in the third E-mail address. If E-mail addresses match for name-matching records in both the lists 62 and 56, then the computer program proceeds to block 168 for further processing. When block 168 is executed because E-mail addresses match between records in the lists 62 and 56, all records in the registrant list 62 which match last and first names and E-mail address or telephone number with the record from the in-block list 56 are omitted from the out-of-block list 64.

If the last and first names in a pair of records in the lists 62 and 56 match but there exists more than one instance of matching first and last names in the registrant list 62 and if both telephone number and E-mail address matching fail, then the computer program in decision block 192 uses the required Zip or postal codes in attempting to identify a record to be omitted from the out-of-block list 64. If there is only one record in the registrant list 62 having a Zip or postal code which matches the Zip or postal code in the in-block list 56, then the computer program proceeds to block 168 which excludes the matching record from the out-of-block list 64. If there is more than one record in the registrant list 62 with last and first names and Zip or postal code matching those in the in-block list 56, then block 168 excludes only the first such name from the out-of-block list 64 and not any others.

In comparing a pair of Zip or postal codes, white space, hyphens, and/or periods are removed from both codes, e.g. 94040-1234→940401234, before they are compared. If any letters, e.g. a-z, occur in the Zip or postal code they are all converted to uppercase before the codes are compared. If either of the Zip or postal codes to be compared contain a letter (A-Z) check for an exact match (i.e., assume these are international postal codes and avoid interpreting them). In this way both Zip or postal codes being compared contain only digits. If either Zip or postal code exceeds five (5) digits, the computer program compares only the first five (5) digits. Thus, the Zip or postal code 940401234 matches the Zip or postal code 94040. If either Zip or postal code contains fewer than five (5) digits, the computer program assumes that leading zeros (0) have been removed. To address a possibility that leading zeros (0) have been removed, the computer program prefixes short Zip or postal codes with leading zeros (0) until they are five (5) digits long. Prefixing short Zip or postal codes with leading zeros (0), ensures that a Zip or postal code of “239” matches a Zip or postal code of “00239” or of “002391234.”

If the last and first names in a pair of records in the lists 62 and 56 match but there exists more than one instance of matching first and last names in the registrant list 62 and if telephone number, E-mail address and Zip or postal code matching fail, then the computer program in decision block 194 uses the required city data in attempting to identify a record to be omitted from the out-of-block list 64. If there is only one record in the registrant list 62 for which the city data matches the city data in the in-block list 56, then the computer program proceeds to block 168 which excludes the matching record from the out-of-block list 64. If there is more than one record in the registrant list 62 with last and first names and city data matching those in the in-block list 56, then block 168 excludes only the first such record from the out-of-block list 64 and not any others.

If the last and first names in a pair of records in the lists 62 and 56 match but there exists more than one instance of matching first and last names in the registrant list 62 and if telephone number, E-mail address, Zip or postal code and city data matching fail, then the computer program proceeds via junction block 172 to block 174. When block 174 is executed the computer program:

1. selects the next records in each of the sorted lists 62 and 56 for comparison; and

2. returns to the decision block 156 via the junction block 154.

Producing the
Match List 84

A detailed flow chart formed by combining FIGS. 9A and 9B depicts the preferred process, performed by the hotel's computer 72, for matching records between the out-of-block list 64 and the hotel's guest list 76. When pairs of records in the lists 64 and 76 match, both records are added to the match list 84. The match list 84 obtained in this way contains at least a pair of matching records that appear both in the out-of-block list 64 and in the guest list 76. As explained in greater detail below, the match list 84 may in some instances actually contain multiple records from the out-of-block list 64 which match a record from the guest list 76.

Initial matching between records in the lists 64 and 76 relies upon last name and first names in a pair of records selected from the lists 64 and 76. The computer program executed by the hotel's computer 72 uses additional information including optional information, such as city, Zip or postal code, phone number, and E-mail address, for resolving matches between a name appearing in the guest list 76 and several similar names appearing in the out-of-block list 64 thereby avoiding false matches. Matching pairs of records in the lists 64 and 76 is intended to err in favor of including in the match list 84 records from the lists 64 and 76. If a record is erroneously included in the match list 84, presumably personnel employed by the hotel 26a-26d will note the error while validating and accepting individual matches during inspection of the match list 84.

Before inputting the out-of-block list 64 into the hotel's computer 72 depicted in block 92 of FIG. 3, to improve audit accuracy preferably hotel personnel review the guest list 76 to ensure that it lacks duplicate records, and to the maximum extent practicable includes complete data for every guest. Matching records between the out-of-block list 64 and the guest list 76 depicted in block 126 of FIG. 3 begins in block 202 of FIG. 9A with case-insensitive sorting of both of the lists 64 and 76 by last name and first name, preferably in ascending order. Furthermore, to facilitate comparison data extracted from the pair of records is regularized such as removing all white space from data including last, first and company names, treat upper and lower case letters the same, and ignore punctuation.

The computer program executed by the hotel's computer 72 then proceeds down the sorted lists 64 and 76 maintaining coordination between the last names and first names in records being compared. Proceeding through junction block 204, the computer program first determines in decision block 206 if the last names in a pair of records match exactly. If the last names do not match exactly, the computer program proceeds to block 208 to select another pair of records from the sorted lists 64 and 76 for comparison.

In block 208, selecting the next pair of records to be compared from the sorted lists 64 and 76 maintains alphabetic coordination between records in the lists 64 and 76. Thus, if the last name in the guest list 76 is alphabetically below the last name in the out-of-block list 64, then the computer program selects the next record in the out-of-block list 64 for comparison with the currently selected name in the guest list 76. Conversely, if the last name in the guest list 76 is alphabetically above the last name in the out-of-block list 64, then the computer program selects the next record in the guest list 76 for comparison with the currently selected name in the out-of-block list 64. After a new pair of records have been selected for comparison from the sorted lists 64 and 76, the computer program returns to the decision block 206 via the junction block 204.

If the last names in a pair of records match exactly, the computer program then determines in decision block 212 if the first names in the records match. However, differing from the exact matching required for last names, matching of first names uses only the first five (5) characters in the first names of both records. If either first name is shorter than five (5) characters, e.g. if one is simply an initial, the computer program executed by the hotel's computer 72 requires that the two (2) first names match up to the length of the shorter of the names. If the last names match exactly but the first names do not match, the computer program proceeds to block 214 to select the next pair of records to be compared from each of the sorted lists 64 and 76.

Similar to block 208, in block 214 selecting the next pair of records to be compared from the sorted lists 64 and 76 maintains alphabetic coordination between records in the lists 64 and 76. Thus, if the first name in the guest list 76 is alphabetically below the first name in the out-of-block list 64, then the computer program selects the next record in the out-of-block list 64 for comparison with the currently selected name in the guest list 76. Conversely, if the first name in the guest list 76 is alphabetically above the first name in the out-of-block list 64, then the computer program selects the next record in the guest list 76 for comparison with the currently selected name in the out-of-block list 64. After a new pair of records have been selected for comparison from the sorted lists 64 and 76, the computer program returns to the decision block 206 via the junction block 204.

If the last and first names in a pair of records match as described above, the computer program then determines in decision block 216 if there exists only a single instance of the first and last names in the out-of-block list 64. If there exists only a single instance of the matching first and last names in the out-of-block list 64, then the computer program executed by the hotel's computer 72 proceeds to block 218 for adding the matched pair of records from the lists 64 and 76 to the match list 84. After adding the matched pair of records to the match list 84, then the computer program proceeds to block 224. When block 224 is executed because there exists only a single instance of matching first and last names in the out-of-block list 64, the computer program:

1. selects the next records in each of the sorted lists 64 and 76 for comparison; and

2. returns to the decision block 206 via the junction block 204.

If the last and first names in a pair of records in the lists 64 and 76 match but there exists more than one instance of matching first and last names in the out-of-block list 64 and if an optional telephone number exists for the name-matching record in the guest list 76, then for each matching name in the out-of-block list 64 having an optional telephone number the computer program determines in decision block 232 if the telephone numbers match. If telephone numbers in both lists 64 and 76 match for name-matching records, then the computer program proceeds to block 218 for further processing. When block 218 is executed because telephone numbers match between records in the lists 64 and 76, all records in the out-of-block list 64 which match last and first names and telephone number or E-mail address with the record from the guest list 76 are added to the match list 84 together with the record from the guest list 76.

Before comparing a pair of telephone numbers, white space, parentheses, hyphens, and/or periods are removed from both numbers. If an alphabetic character occurs in the telephone number, presumably it precedes an extension number (e.g., “x 123” or “ext 123”). In comparing the pair of telephone numbers all strings of characters that begins with an alphabetic character are ignored. Telephone numbers match if the last seven digits of the phone number match exactly. For example, 1-950-331-7175 matches 950-331-7175 or just 331-7175.

If the last and first names in a pair of records in the lists 64 and 76 match but there exists more than one instance of matching first and last names in the out-of-block list 64 and telephone number matching fails and if an optional E-mail address exists for the name-matching record in the guest list 76, then for each matching name in the out-of-block list 64 having an optional E-mail address the computer program determines in decision block 234 if the E-mail addresses match. Except for upper and lower case, E-mail addresses must match exactly. Thus, the E-mail address
“Richard.Thompson@RoomCHECKS.com” matches the E-mail address
“richard.thompson@roomchecks.com”, but does not match the E-mail address
“richardthompson@roomchecks.com” due to the period (.) omitted between “richard” and “thompson” in the third E-mail address. If E-mail addresses match for name-matching records in both the lists 64 and 76, then the computer program proceeds to block 218 for further processing. When block 218 is executed because E-mail addresses match between records in the lists 64 and 76, all records in the out-of-block list 64 which match last and first names and E-mail address or telephone number with the record from the guest list 76 are added to the match list 84 together with the record from the guest list 76.

If the last and first names in a pair of records in the lists 64 and 76 match but there exists more than one instance of matching first and last names in the out-of-block list 64 and if both telephone number and E-mail address matching fail, then the computer program in decision block 242 uses the required Zip or postal codes in attempting to identify a matching record in the out-of-block list 64. If a record in the out-of-block list 64 having a Zip or postal code matches the Zip or postal code in the guest list 76, then the computer program proceeds to block 218 for further processing. When block 218 is executed because Zip or postal codes match between records in the lists 64 and 76, all records in the out-of-block list 64 which match last and first names and Zip or postal code with the record from the guest list 76 are added to the match list 84 together with the record from the guest list 76.

In comparing a pair of Zip or postal codes, white space, hyphens, and/or periods are removed from both codes, e.g. 94040-1234→940401234, before they are compared. If any letters, e.g. a-z, occur in the Zip or postal code they are all converted to uppercase before the codes are compared. If either of the Zip or postal codes to be compared contain a letter (A-Z) check for an exact match (i.e., assume these are international postal codes and avoid interpreting them). In this way both Zip or postal codes being compared contain only digits. If either Zip or postal code exceeds five (5) digits, the computer program compares only the first five (5) digits. Thus, the Zip or postal code 940401234 matches the Zip or postal code 94040. If either Zip or postal code contains fewer than five (5) digits, the computer program assumes that leading zeros (0) have been removed. To address a possibility that leading zeros (0) have been removed, the computer program prefixes short Zip or postal codes with leading zeros (0) until they are five (5) digits long. Prefixing short Zip or postal codes with leading zeros (0), ensures that a Zip or postal code of “239” matches a Zip or postal code of “00239” or of “002391234.”

If the last and first names in a pair of records in the lists 64 and 76 match but there exists more than one instance of matching first and last names in the out-of-block list 64 and if telephone number, E-mail address and Zip or postal code matching fail, then the computer program in decision block 244 uses the required city data in attempting to identify a matching record in the out-of-block list 64. If a record in the out-of-block list 64 having city data matches the city data in the guest list 76, then the computer program proceeds to block 218 for further processing. When block 218 is executed because city data matches between records in the lists 64 and 76, all records in the out-of-block list 64 which match last and first names and city data with the record from the guest list 76 are added to the match list 84 together with the record from the guest list 76.

If the last and first names in a pair of records in the lists 64 and 76 match but there exists more than one instance of matching first and last names in the out-of-block list 64 and if telephone number, E-mail address, Zip or postal code and city data matching all fail, then the computer program proceeds to block 218 for further processing. When block 218 is executed because multiple records have matching first and last names while lacking a matching pair of telephone numbers, E-mail addresses, Zip or postal codes or city data, then all the records in the out-of-block list 64 with matching last and first names are added to the match list 84 together with the record from the guest list 76. After all records in the out-of-block list 64 and the record from the guest list 76 with matching last and first names are added to the match list 84, the computer program proceeds to block 224 to select the next pair of records in each of the sorted lists 64 and 76 for comparison, and then returns to the decision block 206 via the junction block 204.

To assist hotel personnel in validating and accepting individual matches as being a genuine event registrant who made an out-of-block room reservation, when records from the lists 64 and 76 are added to the match list 84 in block 218, data indicating the basis upon which the records match accompanies the matched records in the match list 84.

Audit Reporting

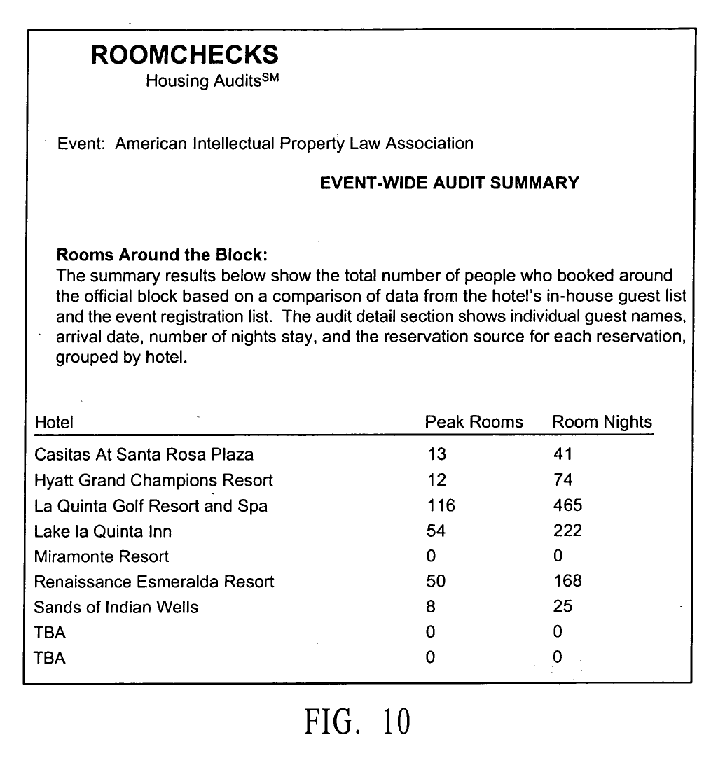

FIG. 10 depicts a display of the preferred summary audit report 88 which the sponsor's computer 54 may download from the housing-audit server 52 presenting summary information for various hotels 26a-26d. As is readily apparent to those skilled in the art, the report generator 112 included in the housing-audit server 52 can readily produce reports more detailed than that of FIG. 10 for each individual hotel 26a-26d. Such more detailed reports may include only certain specified types of detailed information about individual registrants identified in the match lists 84.

Preferably, one type of audit report 88 is available in a structured format that can be read using a text editor or Microsoft Corporation's Excel spreadsheet computer program. This type of audit report 88 can be copied via the clipboard of the sponsor's computer 54 into an Excel spreadsheet. Using an Excel spreadsheet, audit data in the audit report 88 can be sorted to expedite review and verification. For example, an Excel spreadsheet containing the audit data provided by the audit report 88 may be sorted by Zip or postal code or by city to organized the names geographically, or sorted by company to obtain a list of registrants ordered by company name. After sorting an Excel spreadsheet containing the audit data, that data can be reordered back into its original order by sorting on the “match number” column and selecting in “ascending order”. Re-sorting the Excel spreadsheet containing data from the audit report 88 in this way shows two adjacent rows of data for each name, one for the out-of-block list 64 and one for the guest list 76.

To further preserve confidentiality of data provided by the hotels 26a-26d, analogous to the inability of the hotels 26a-26d to access all the data in the out-of-block list 64 audit reports 88 provide only aggregations of certain types of information latent in the match list 84. While audit reports 88 may include some detailed information about a hotel guest such as their first and last names, company name, city, Zip code or postal code, date of arrival, phone number, E-mail address, etc. extracted from the match list 84, other detailed information about individual guests such as reservation booking date, room type, room rate, reservation source, etc. never appears in an audit report 88. Instead, audit reports 88 contain only aggregated information for specific types of hotel information such as reservation booking date, room type, room rate, reservation source, etc. For example, an audit report 88 may disclose that a particular percentage of an event's attendees identified in the out-of-block list 64 who stayed at a particular hotel booked their reservation via the Internet.

Confidentiality

To preserve information confidentiality, the housing audit system 50 is preferably implemented using the latest security technology. The housing audit system 50 preferably uses Secure Sockets Layer (“SSL”) for transmitting data via the Internet of:

1. the out-of-block list 64 to the housing-audit server 52 and from the housing-audit server 52 to the hotel's computer 72;

2. the match list 84 to the housing-audit server 52; and

3. the audit report 88 to the sponsor's computer 54. SSL, a standard encryption protocol used on the Internet for protecting sensitive data, encrypts information so it can't be intercepted. An explanation in laymen's terms of how SSL works may be obtained from
http://www.interwebinc.com/security/ssl.html.

To secure the sponsor's computer 54, the housing-audit server 52 and the hotel's computer 72, software for the housing audit system 50 is implemented using Microsoft Corporation's NET Frame-work. Presently, NET Framework is a new generation technology developed by Microsoft Corporation that ensures completely secure distribution and use of applications via the Internet. Any application implemented using .NET Framework runs within NET which strictly controls the application's access to a computer resources. This control includes the application's ability to read or write files, to access the computer's network, etc. .NET Framework confines an application to run in tightly constrained, system-administrator-defined security contexts.

Software for the housing audit system 50 runs in the default security setting for .NET, which is the strictest setting. Within the .NET Framework security cordon, the computer programs executed by the sponsor's computer 54 or hotel's computer 72 can access only those files identified using the Windows operating system's “FIND FILE” function, namely the registrant list 62, the in-block list 56 and the guest list 76. The application computer programs executed by the sponsor's computer 54 and by the hotel's computer 72 cannot create or modify any files at all. Such computer programs can only copy data in the registrant list 62, in-block list 56 or the guest list 76 to the computer's clipboard, i.e. a location where items are stored temporarily during a cut and paste operation. Data stored by a NET Framework application computer program to the computer's clipboard can be subsequently pasted into another application computer program executed by the sponsor's computer 54 or by the hotel's computer 72. Similarly, these NET Framework computer programs cannot access a network connected to the computer 54 or 72, or any database or other applications.

Implemented in this way, the sponsor 24 has access within the .NET Framework computer program to only the registrant list 62 and the in-block list 56 input to the sponsor's computer 54, and to audit reports 88 produced by the housing-audit server 52. Correspondingly, each of the hotels 26a-26d being audited gains access to only that information in the out-of-block list 64 downloaded from the housing-audit server 52 which the .NET Framework computer program executed by the hotel's computer 72 determines matches information in the guest list 76 input to the hotel's computer 72. Consequently, no hotel 26a-26d can view the entire out-of-block list 64, or any audit data uploaded by any other hotel 26a-26d. Correspondingly, the sponsor 24 can view only that audit data uploaded by the hotels 26a-26d that the housing-audit server 52 includes in the various diffeent types of audit reports 88. copy data in the registrant list 62, in-block list 56 or the guest list 76 to the computer's clipboard, i.e. a location where items are stored temporarily during a cut and paste operation. Data stored by a NET Framework application computer program to the computer's clipboard can be subsequently pasted into another application computer program executed by the sponsor's computer 54 or by the hotel's computer 72. Similarly, these NET Framework computer programs cannot access a network connected to the computer 54 or 72, or any database or other applications.

Implemented in this way, the sponsor 24 has access within the .NET Framework computer program to only the registrant list 62 and the in-block list 56 input to the sponsor's computer 54, and to audit reports 88 produced by the housing-audit server 52. Correspondingly, each of the hotels 26a-26d being audited gains access to only that information in the out-of-block list 64 downloaded from the housing-audit server 52 which the NET Framework computer program executed by the hotel's computer 72 determines matches information in the guest list 76 input to the hotel's computer 72. Consequently, no hotel 26a-26d can view the entire out-of-block list 64, or any audit data uploaded by any other hotel 26a-26d. Correspondingly, the sponsor 24 can view only that audit data uploaded by the hotels 26a-26d that the housing-audit server 52 includes in the various different types of audit reports 88.

Although the present disclosure is being made in terms of the presently preferred embodiment, it is to be understood that such disclosure is purely illustrative and is not to be interpreted as limiting. Thus while all communications between the sponsor's computer 54 and the housing-audit server 52, and between the hotel's computer 72 and the housing-audit server 52 preferably occur via the Internet, the present disclosure envisions any form of inter-computer communication. Such inter-computer communication may occur via either a public network such as the Internet or via a private network including dial-up communication directly between the sponsor's computer 54 and/or the hotel's computer 72 and the housing-audit server 52.

While presently software of the housing audit system 50 is preferably implemented using NET Framework Version 1.1, the software could also be implemented using a different technology such as Sun Microsystems' Java object-oriented, platform-independent, multithreaded programming environment. Java technology allows writing software on one platform and running it on practically any other platform. Java technology permits creating multi-threaded programs that run within Web browsers and Web services. Also, Java technology permits combining reusable Java objects to quickly create unique and highly customized server-side applications, such as online forums, stores, polls, HTML forms processing, and secure transactions.

For a .NET Framework implementation of the housing audit system 50, a sponsor 24 auditing occupancy outside the sponsor's room block at hotels 26a-26d, and a hotel 26a-26d participating in an occupancy audit must provide respectively a sponsor's computer 54 and a hotel's computer 72 having at least the following characteristics.

An Intel Pentium class processor, 120 MHz or higher
A minimum of 32 MB RAM (96 MB or higher is recommended)
A video display of at least 800 × 600 pixels and 256
colors
Microsoft Corporation's Windows 98, Windows Me, Windows
NT (with Service Pack 6a or higher), Windows 2000, or
Window XP operating system
Microsoft Corporation's Internet Explorer (IE) browser,
version 5.0.1 or higher
Broadband access to the Internet (DSL line, cable modem,
T-1 line, etc.)
Any firewall must allow normal Internet access: HTTP,
using the default port (80) and HTTPS (i.e., SSL), using
the default port (443)
Microsoft Corporation's .NET Framework Version 1.1, or
perhaps higher version, Redistributable Package

Microsoft Corporation's .NET Framework Version 1.1 is available via the Internet as a free download from:

http://www.microsoft.com/downloads/details.aspx?FamilyI
D=262d25e3-f589-4842-8157-034d1e7cf3a

Installing Microsoft Corporation's .NET Framework Version 1.1 usually takes approximately five (5) minutes, does not require rebooting the computer, and occupies approximately 150 MB of hard disk space. After .NET Framework Version 1.1 or higher Redistributable Package has been downloaded and installed, the computer programs executed respectively by the sponsor's computer 54 and by the hotel's computer 72 can then be downloaded from the housing-audit server 52.

Information regarding .NET Framework is available in Microsoft Corporation's “.NET Framework Version 1.1 Product Overview.” This document can be downloaded from Microsoft Corporation's Internet Web site.

http://msdn.microsoft.com/netframework/technologyinfo/defaul
t.aspx.

Additional, more detailed information regarding .NET Framework can be downloaded from several Internet Web sites.

Microsoft Corporation's “Understanding .NET” White Paper:
http://www.directionsonmicrosoft.com/sample/DOMIS/resea
rch/2001/07jul/nav.html
(The executive summary is available on-line, the full
report must be purchased)
Microsoft Corporation's Developer Network web pages on
NET Framework Security:
http://msdn.microsoft.com/library/default.asp?url=/libr
ary/en-us/cpguide/html/cpconnetframeworksecurity.asp
A Security Evaluation of Microsoft .NET Framework vs.
IBM's Websphere by @stake, Inc., an independent security
consulting firm:
http://www.atstake.com/research/reports/eval_ms_ibm/
Foundstone Inc.'s White paper “Security in the Microsoft
.NET Framework”:
http://www.foundstone.com/pdf/dotnet-security-frame-
work.pdf
A third-party technical description of the security
features in .NET
http://www.gotdotnet.com/team/clr/about_security.aspx

While preferably to provide optimum confidentiality respectively for the registrant list 62, for the in-block list 56 and for the guest list 76 the present disclosure envisions respectively producing the out-of-block list 64 using the sponsor's computer 54, and producing the match list 84 using the hotel's computer 72, in accordance with the present disclosure a trusted housing-audit server 52 may alternatively be utilized for producing the out-of-block list 64 and/or match list 84. In such an alternative housing audit system the sponsor's computer 54 uploads the registrant list 62 and the in-block list 56 to the housing-audit server 52 which produces the out-of-block list 64. Similarly, in such an alternative housing audit system the hotel's computer 72 uploads the guest list 76 to the housing-audit server 52, and interacts with the housing-audit server 52 during production of the match list 84 for validating and accepting individual matches as being a genuine event registrant who made an out-of-block room reservation.

Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:

1. not invoke paragraph 6 of 35 U.S.C. § 112 as it exists on the date of filing hereof unless the phrase “means for” appears expressly in the claim's text;

2. omit all elements, steps, or functions not expressly appearing therein unless the element, step or function is expressly described as “essential” or “critical;”

3. not be limited by any other aspect of the present disclosure which does not appear explicitly in the claim's text unless the element, step or function is expressly described as “essential” or “critical;” and

4. when including the transition word “comprises” or “comprising” or any variation thereof, encompass a non-exclusive inclusion, such that a claim which encompasses a process, method, article, or apparatus that comprises a list of steps or elements includes not only

What is claimed is:

1. A method by which a sponsor audits temporary housing occupied by registrants while attending an event located in a geographical region, prior to the event the sponsor performing the steps of:
a. arranging a commitment with at least one hotel, that rents short-term lodging, to reserve for booking via the sponsor a number of rooms during a block of dates thereby making the block of rooms available for occupancy by registrants while attending the event; and
b. arranging with a housing provider to mediate between registrants for the event and the at least one hotel in booking reservations for lodging registrants attending the event;
the auditing method comprising the steps of:
a. producing using a computer an out-of-block list, that contains records which identify registrants who may have booked lodging outside the block of rooms committed by the at least one hotel, by deleting from a machine-readable registrant list, that contains records which identify registrants for the event, those records thereof which identify an individual who is also identified in a machine-readable in-block list, that contains records which identify attendees who have booked lodging through the housing provider;
b. storing the out-of-block list on a housing-audit server;
c. producing using a computer a match list, that contains records which identify registrants who have booked lodging with the at least one hotel outside the block of rooms, by matching records in the out-of-block list with records in a machine-readable guest list prepared by the hotel, that contains records which identify guests who have booked lodging with the hotel;
e. storing the match list on the housing-audit server; and
f. transmitting from the housing-audit server to the sponsor a report which correlates records in the out-of-block list with records in the match list.

2. The auditing method of claim 1 wherein the housing provider mediating between registrants and the at least one hotel in booking reservations is part of the sponsor.

3. The auditing method of claim 1 wherein the housing provider mediating between registrants and the at least one hotel in booking reservations is an enterprise distinct from the sponsor.

4. The auditing method of claim 3 wherein a convention visitors bureau (“CVB”) operating in the geographical region for the event is the housing provider.

5. The auditing method of claim 1 wherein individual records in the registrant list for each registrant include data items selected from a group consisting of last name, first name, City, Zip code and postal code.

6. The auditing method of claim 1 wherein individual data items appearing in individual records of the registrant list may be marked to be ignored during deletion of records therefrom.

7. The auditing method of claim 1 wherein individual records in the in-block list for each attendee include data items selected from a group consisting of last name, first name, City, Zip code and postal code.

8. The auditing method of claim 1 wherein individual data items appearing in individual records of the in-block list may be marked to be ignored during deletion of records from the registrant list.

9. The auditing method of claim 1 wherein individual records in the guest list for each guest include data items selected from a group consisting of last name, first name, City, Zip code and postal code, date of arrival, date of departure and number of nights of stay.

10. The auditing method of claim 1 wherein individual data items appearing in individual records of the guest list may be marked to be ignored during matching of records between the out-of-block list and the guest list.

11. The auditing method of claim 1 wherein during match list preparation personnel of the hotel validate and accept individual matches between records in the out-of-block list and records in the guest list as identifying a genuine event registrant who made an out-of-block room reservation.

12. The auditing method of claim 1 wherein the sponsor operates the computer that produces the out-of-block list, and the out-of-block list is uploaded from the computer operated by the sponsor to the housing-audit server.

13. The auditing method of claim 12 further comprising the step of downloading a computer program from the housing-audit server to the computer operated by the sponsor for use in producing the out-of-block list.

14. The auditing method of claim 1 wherein the hotel operates the computer that produces the match list, a copy of the out-of-block list being downloaded from the housing-audit server to the computer operated by the hotel for record matching with the guest list in producing the match list, and the match list thus produced is uploaded from the computer operated by the hotel to the housing-audit server.

15. The auditing method of claim 14 further comprising the step of downloading a computer program from the housing-audit server to the computer operated by the hotel for use in producing the match list.

16. The auditing method of claim 14 wherein, during match list preparation by the computer operated by the hotel before uploading the match list to the housing-audit server, personnel of the hotel validate and accept individual matches between records in the out-of-block list and records in the guest list as identifying a genuine event registrant who made an out-of-block room reservation.

17. The auditing method of claim 1 wherein the in-block list is an empty file whereby the out-of-block list includes all records in the registrant list, and wherein the guest list prepared by the hotel excludes records for all guests booked into the block of rooms by the housing provider.

18. A housing-audit server adapted for use by a sponsor in auditing temporary housing occupied by registrants while attending an event located in a geographical region, prior to the event the sponsor having:
a. arranged a commitment with at least one hotel, that rents short-term lodging, to reserve for booking via the sponsor a number of rooms during a block of dates thereby making the block of rooms available for occupancy by registrants while attending the event;
b. arranged with a housing provider to mediate between registrants for the event and the at least one hotel in booking reservations for lodging registrants attending the event;
c. arranged for computer production of an out-of-block list, that contains records which identify registrants who may have booked lodging outside the block of rooms committed by the at least one hotel, by deleting from a machine-readable registrant list, that contains records which identify registrants for the event, those records thereof which identify an individual who is also identified in a machine-readable in-block list, that contains records which identify attendees who have booked lodging through the housing provider; and
d. arranged for computer production of a match list, that contains records which identify registrants who have booked lodging with the at least one hotel outside the block of rooms, by matching records in the out-of-block list with records in a machine-readable guest list prepared by the hotel, that contains records which identify guests who have booked lodging with the hotel;
the housing-audit server comprising:
a. storage for the out-of-block list;
b. storage for the match list; and
c. transmission of a report which correlates records in the out-of-block list with records in the match list to the sponsor.

19. The housing-audit server of claim 18 wherein the housing provider mediating between registrants and the at least one hotel in booking reservations is part of the sponsor.

20. The housing-audit server of claim 18 wherein the housing provider mediating between registrants and the at least one hotel in booking reservations is an enterprise distinct from the sponsor.

21. The housing-audit server of claim 20 wherein a convention visitors bureau (“CVB”) operating in the geographical region for the event is the housing provider.

22. The housing-audit server of claim 18 wherein individual records in the registrant list for each registrant include data items selected from a group consisting of last name, first name, City, Zip code and postal code.

23. The housing-audit server of claim 18 wherein individual data items appearing in individual records of the registrant list may be marked to be ignored during deletion of records therefrom.

24. The housing-audit server of claim 18 wherein individual records in the in-block list for each attendee include data items selected from a group consisting of last name, first name, City, Zip code and postal code.

25. The housing-audit server of claim 18 wherein individual data items appearing in individual records of the in-block list may be marked to be ignored during deletion of records from the registrant list.

26. The housing-audit server of claim 18 wherein individual records in the guest list for each guest include data items selected from a group consisting of last name, first name, City, Zip code and postal code, date of arrival, date of departure and number of nights of stay.

27. The housing-audit server of claim 18 wherein individual data items appearing in individual records of the guest list may be marked to be ignored during matching of records between the out-of-block list and the guest list.

28. The housing-audit server of claim 18 wherein during match list preparation personnel of the hotel validate and accept individual matches between records in the out-of-block list and records in the guest list as identifying a genuine event registrant who made an out-of-block room reservation.

29. The housing-audit server of claim 18 wherein the sponsor operates the computer that produces the out-of-block list, and the out-of-block list is uploaded from the computer operated by the sponsor to the housing-audit server.

30. The housing-audit server of claim 29 wherein a computer program is downloaded from the housing-audit server to the computer operated by the sponsor for use in producing the out-of-block list.

31. The housing-audit server of claim 18 wherein the hotel operates the computer that produces the match list, a copy of the out-of-block list being downloaded from the housing-audit server to the computer operated by the hotel for record matching with the guest list in producing the match list, and the match list thus produced is uploaded from the computer operated by the hotel to the housing-audit server.

32. The housing-audit server of claim 31 wherein a computer program is downloaded from the housing-audit server to the computer operated by the hotel for use in producing the match list.

33. The housing-audit server of claim 31 wherein, during match list preparation by the computer operated by the hotel before uploading the match list to the housing-audit server, personnel of the hotel validate and accept individual matches between records in the out-of-block list and records in the guest list as identifying a genuine event registrant who made an out-of-block room reservation.

34. The housing-audit server of claim 18 wherein the in-block list is an empty file whereby the out-of-block list includes all records in the registrant list, and wherein the guest list prepared by the hotel excludes records for all guests booked into the block of rooms by the housing provider.
